(19) United States
(12) Patent Application Publication
(10) Pub. No.: US 2026/0017657 A1
(43) Pub. Date: Jan. 15, 2026

(54) Transaction Data Processing Methods and Systems

(71) Applicant: Tencent Technology (Shenzhen) Company Limited, Shenzhen (CN)

(72) Inventors: Shaoming Wang, Shenzhen (CN); Jinkun Hou, Shenzhen (CN); Runzeng Guo, Shenzhen (CN); Nanjin Chen, Shenzhen (CN)

(21) Appl. No.: 19/335,486

(22) Filed: Sep. 22, 2025

Related U.S. Application Data
(63) Continuation of application No. PCT/CN2024/112316, filed on Aug. 15, 2024.

(30) Foreign Application Priority Data
Oct. 12, 2023 (CN) 2023113267679

(51) Int. Cl. G06Q 20/40; G10L 17/00

(52) U.S. Cl. CPC G06Q 20/40145; G10L 17/00

(57) ABSTRACT

Techniques for processing transaction data using biometric recognition are described. A payment receiving device constructs a transaction order and transmits a voice enabling instruction initiated by a payee. A biometric recognition device performs one-way communication with the payment receiving device, extracts a voiceprint feature from the instruction, and matches it against a stored target voiceprint. If a match is found, the biometric recognition function is enabled to collect a payer's biometric feature. A payer account is obtained based on the collected feature, and transaction payment is completed using the payer account, a virtual resource, and a payee account specified in the transaction order. By employing these techniques, repeated processing during payment transactions is reduced and overall transaction efficiency is improved.

### CROSS-REFERENCE TO RELATED APPLICATIONS

This application is a Continuation of PCT Application No. PCT/CN2024/112316, filed Aug. 15, 2024, which claims priority to Chinese Patent Application No. 202311326767.9, filed with the China National Intellectual Property Administration on Oct. 12, 2023 and each entitled “TRANSACTION DATA PROCESSING METHOD AND APPARATUS, AND ELECTRONIC DEVICE”, each of which is incorporated herein by reference in its entirety.

### FIELD

This application relates to the field of computer technologies, and in particular, to a transaction data processing method and apparatus, and an electronic device.

### BACKGROUND

Currently, during online payment, a biometric recognition transaction device may be used to perform biometric recognition, to authenticate an identity of a user. Therefore, after authentication on the identity of the user succeeds, account information of the user is obtained, and then a payment receiving device (for example, a point of sales (POS) machine) is used to receive payment, to complete transaction payment.

However, it is found in practice that communication between two devices (that is, the biometric recognition transaction device and the payment receiving device) that jointly participate in and complete transaction payment is usually in a unidirectional communication mode. It means that in the unidirectional communication mode, the biometric recognition transaction device may transmit information to the payment receiving device in a unidirectional manner, but the payment receiving device cannot transmit information to the biometric recognition transaction device. Consequently, the biometric recognition transaction device cannot perceive status information of the payment receiving device, for example, cannot perceive whether the payment receiving device currently satisfies a condition for performing biometric payment. Therefore, when the payment receiving device does not satisfy the condition for performing biometric payment, once a biometric feature of a payer (for example, the user) is collected by using the biometric recognition transaction device (the collected feature is essentially an invalid biometric feature), the biometric recognition transaction device enters an order query state. Consequently, when transaction payment is performed for the transaction by using the biometric feature, the transaction fails because the transaction payment using the invalid biometric feature fails. Therefore, if transaction payment needs to be continued to be performed for the transaction, a biometric feature of the payer (for example, the user) needs to be re-collected by using the biometric recognition transaction device, and biometric recognition is performed again by using the re-collected biometric feature. Consequently, a long online payment time needs to be consumed, and transaction data generated in the transaction payment process is repeatedly processed. As a result, transaction processing efficiency is affected.

### SUMMARY

Aspects as described herein provide a transaction data processing method and apparatus, a device, a storage medium, and a computer program product, to reduce a probability of repeated processing when transaction payment is performed through biometric recognition, and improve transaction processing efficiency in a transaction payment process.

An aspect as described herein provides a transaction data processing method. The method is applied to a biometric recognition transaction device, the biometric recognition transaction device is configured to perform unidirectional communication to a payment receiving device, and the method includes:
receiving a voice enabling instruction initiated by a payee, the voice enabling instruction being initiated by the payee after the payee constructs a transaction order for a target transaction by using the payment receiving device, and the voice enabling instruction being configured for enabling a biometric recognition function of the biometric recognition transaction device;
extracting a voiceprint feature in the voice enabling instruction, performing matching on the voiceprint feature in the voice enabling instruction and a stored target voiceprint feature, and enabling the biometric recognition function according to the voice enabling instruction if matching succeeds;
collecting a biometric feature of a payer by using the biometric recognition function, and obtaining a payer account of the payer based on the collected biometric feature; and
performing transaction payment for the transaction order based on the payer account and a virtual resource required for the target transaction.

Another aspect as described herein provides a transaction data processing apparatus. The apparatus is applied to a biometric recognition transaction device, the biometric recognition transaction device is configured to perform unidirectional communication to a payment receiving device, and the apparatus includes:
a voice enabling instruction receiving module, configured to receive a voice enabling instruction initiated by a payee, the voice enabling instruction being initiated by the payee after the payee constructs a transaction order for a target transaction by using the payment receiving device, and the voice enabling instruction being configured for enabling a biometric recognition function of the biometric recognition transaction device;
a voiceprint recognition module, configured to: extract a voiceprint feature in the voice enabling instruction, perform matching on the voiceprint feature in the voice enabling instruction and a stored target voiceprint feature, and enable the biometric recognition function according to the voice enabling instruction if matching succeeds;
a biometric feature recognition module, configured to: collect a biometric feature of a payer by using the biometric recognition function, and obtain a payer account of the payer based on the collected biometric feature; and
a transaction processing module, configured to perform transaction payment for the transaction order based on the payer account and a virtual resource required for the target transaction.

Another aspect as described herein provides an electronic device. The electronic device includes a processor and a memory.

The memory stores computer instructions executable by the processor. When the computer instructions are invoked by the processor, any one of the foregoing transaction data processing methods may be performed.

Another aspect as described herein provides a computer-readable storage medium. When computer instructions stored in the computer-readable storage medium are executed by a processor of an electronic device, the electronic device is enabled to perform any one of the foregoing transaction data processing methods.

Another aspect as described herein provides a computer program product. The computer program product includes computer instructions, and the computer instructions are stored in a computer-readable storage medium. A processor of an electronic device reads and executes the computer instructions from the computer-readable storage medium, so that the electronic device performs the transaction data processing method provided in the foregoing various illustrative implementations.

In the transaction data processing method provided in aspects as described herein, after the payment receiving device constructs the transaction order for the current transaction, the payee may initiate the voice enabling instruction to the biometric recognition transaction device. In this case, the biometric recognition transaction device may extract the voiceprint feature in the voice enabling instruction, and perform matching on the voiceprint feature extracted from the voice enabling instruction and the pre-collected and stored target voiceprint feature, to recognize whether an identity of the payee can control the biometric recognition transaction device. For example, in aspects as described herein, after matching on the voiceprint feature succeeds, the biometric recognition function of the biometric recognition transaction device may be enabled, to collect the biometric feature of the payer by using the enabled biometric recognition function, so as to obtain the payer account of the payer based on the collected biometric feature, and complete transaction payment based on the payer account and the transaction order. In aspects as described herein, enabling of the biometric recognition function of the biometric recognition transaction device is triggered in a voice manner such as the voice enabling instruction only after the payment receiving device completes creation of the transaction order. In this way, ineffective collection of a biometric feature before the transaction order is created can be avoided, thereby improving an effective collection rate of a biometric feature. In other words, in aspects as described herein, in an entire transaction payment process, the biometric feature of the payer may be scanned and collected based on the enabled biometric recognition function. In this way, when transaction payment is performed through biometric recognition, transaction processing efficiency for the transaction can be effectively improved. In addition, in aspects as described herein, enabling of the biometric recognition function is triggered in the voice manner such as the voice enabling instruction, so that the payment receiving device and the biometric recognition transaction device do not need to perform bidirectional communication. Instead, when the biometric recognition transaction device performs unidirectional communication to the payment receiving device, transaction payment for the transaction order is directly implemented by using the effectively collected biometric feature, thereby improving transaction processing efficiency in the transaction payment process.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 is a schematic diagram of an application environment of a transaction data processing method according to an aspect as described herein.

FIG. 2 is a schematic flowchart of a transaction data processing method according to an aspect as described herein.

FIG. 3 is a schematic diagram of a structure of a biometric recognition transaction device configured to process transaction data according to an aspect as described herein.

FIG. 4 is a schematic diagram of data exchange for enabling a palm-scan payment function of a palm-scan transaction device according to an aspect as described herein.

FIG. 5 is a schematic diagram of data exchange of an entire palm-scan payment process according to an aspect as described herein.

FIG. 6 is a schematic diagram of a structure of a transaction data processing apparatus according to an aspect as described herein.

FIG. 7 is a block diagram of an electronic device configured to process transaction data according to an aspect as described herein.

FIG. 8 is a block diagram of another electronic device configured to process transaction data according to an aspect as described herein.

### DETAILED DESCRIPTION

In the specification, claims, and accompanying drawings of aspects as described herein, terms “first”, “second”, and the like are intended to distinguish between similar objects but do not necessarily indicate a specific order or sequence. Data used in such a way is interchangeable in proper circumstances, so that aspects as described herein described herein can be implemented in a sequence other than the sequence illustrated or described herein. In addition, terms “include”, “have”, and any other variants thereof are intended to cover the non-exclusive inclusion. For example, a process, method, system, product, or server that includes a series of steps or units is not necessarily limited to those expressly listed steps or units, but may include other steps or units not expressly listed or inherent to the process, method, product, or device.

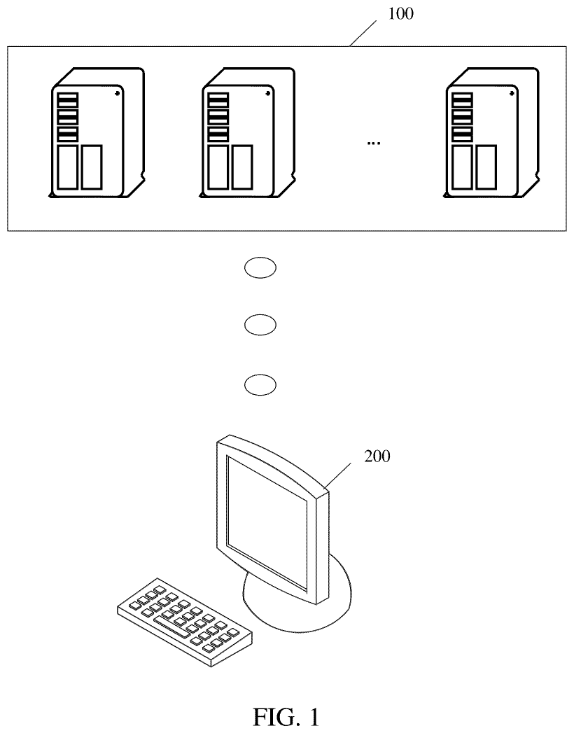

FIG. 1 is a schematic diagram of an application environment of a transaction data processing method according to an aspect as described herein. The application environment may at least include a server 100 and a terminal 200.

In an illustrative aspect, the server 100 may be configured to: receive a biometric feature transmitted by the terminal 200, and perform identity recognition on a payer based on the biometric feature, to perform transaction payment for a transaction in a payment order of the payer when identity recognition succeeds. The server 100 may be an independent physical server, or may be a server cluster including a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In other words, in aspects as described herein, the terminal 200 may be an electronic device that can be configured to extract the biometric feature (for example, a human face feature, a voice feature, a fingerprint feature, a palmprint feature, or a palm vein feature) from a collected target image and transmit the extracted biometric feature to the server 100.

The palmprint feature and the palm vein feature may be different palm features collected when a palm approaches the terminal 200 to perform a palm-scan operation (for example, perform palm-scan payment in a payment scenario). For example, in an implementation, the two palm features may be extracted from a same collected target image. The palmprint feature mainly refers to some external features that are on a skin surface of the palm and that are extracted from the target image, and the palm vein feature refers to some internal features that are hidden under the skin of the palm and that are extracted from the target image.

In some aspects, in another implementation, the palmprint feature and the palm vein feature may be different biometric features collected from different target images when a palm approaches the terminal 200 to perform a palm-scan operation (for example, perform palm-scan payment in a payment scenario). For example, a target image corresponding to the palmprint feature may be a palmprint image, and a target image corresponding to the palm vein feature may be a palm vein image.

Specifically, for example, if the target image collected by the terminal 200 is a palmprint image, the biometric feature recognized and extracted from the palmprint image may be a palmprint feature corresponding to a palmprint. The palmprint refers to various texture lines on the palm surface between the wrist and the fingers. These texture lines not only include some visible principal lines on the palm surface, but also include a large quantity of crease lines on the palm surface. These crease lines are texture lines that are finer and shallower than the principal lines. Therefore, when a camera device is integrated in the terminal 200, and when the palm approaches the terminal 200, the camera device (for example, a camera) may capture a palmprint image including different texture lines (for example, the principal lines and crease lines) on the palm surface.

For another example, if the target image collected by the terminal 200 is a palm vein image, the biometric feature recognized and extracted from the palm vein image may be a palm vein feature corresponding to a palm vein. The palm vein may specifically include a vein system including all veins distributed within a range of the palm. For example, the vein system may at least include a vein faintly visible through the skin of the palm. Hemoglobin in red blood cells in veins is deoxygenated hemoglobin, and the deoxygenated hemoglobin may absorb near-infrared light. Therefore, when an infrared device is integrated in the terminal 200, and when the palm approaches the terminal 200, the palm may be irradiated with near-infrared light emitted by the infrared device. In this case, because a vein part in the palm reflects the near-infrared light, the terminal 200 may collect the palm vein image.

In some aspects, in another implementation, when the terminal 200 does not transmit the biometric feature to the server 100, related transaction data processing may be performed locally on the terminal 200 (that is, in a local storage unit of the terminal 200). For example, specifically, voiceprint recognition may be first performed locally on the terminal 200. When voiceprint recognition is generated, a working status of the terminal 200 is switched (for example, a working status of the terminal 200 for a biometric recognition function is switched from a disabled state to an enabled state). Further, identity recognition may be performed on the payer based on the biometric feature locally on the terminal 200 according to an actual requirement. When identity recognition succeeds, transaction payment is performed for the transaction in the transaction order of the payer.

It can be learned that the terminal 200 may be a device with a biometric feature collection function. That is, in this case, the terminal 200 may be a device that is specially configured to collect a biometric feature and assist the server 100 in performing transaction payment. In addition, the terminal 200 may alternatively be a device that is obtained by adding biometric feature collection to some intelligent devices and that can perform transaction payment based on a biometric feature. For example, the terminal 200 may be an electronic device with a biometric feature collection function, such as a smartphone, a desktop computer, a tablet computer, or a notebook computer. In some aspects, the terminal 200 may alternatively be software run on the electronic device, for example, an application or a mini program. An operating system running on the electronic device in aspects as described herein may include, but is not limited to, an Android system, an iOS system, a Linux system, a Window system, and the like.

In addition, FIG. 1 is only a schematic diagram of an application environment of the transaction data processing method, and aspects as described herein are not limited thereto.

In aspects as described herein, the server 100 and the terminal 200 may be directly or indirectly connected in a wired or wireless communication mode. A specific communication mode between the server 100 and the terminal 200 is not limited in aspects as described herein.

In a transaction data processing method in aspects as described herein, after a payee completes construction of a transaction order for a specific transaction (that is, a target transaction) by using a payment receiving device, the payee initiates a voice enabling instruction. In this way, when a biometric recognition transaction device obtains or collects the voice enabling instruction initiated by the payee, the biometric recognition transaction device may be controlled to enable a biometric recognition function based on a voiceprint feature in the voice enabling instruction, and then a biometric feature of a payer may be collected by using the enabled biometric recognition function, to complete transaction payment for the transaction (that is, the target transaction) in the transaction order based on the collected biometric feature. It can be learned that aspects as described herein clearly point out that the payee needs to trigger enabling of the biometric recognition function in a voice manner when the payment receiving device completes construction of the transaction order. This can avoid a phenomenon that the collected biometric feature is an invalid biometric feature because the payment receiving device starts collecting a biometric feature before completing construction of the transaction order. It means that in aspects as described herein, when the payee triggers enabling of the biometric recognition function in the voice manner, a problem in the related art, in which biometric feature collection needs to be re-performed (that is, repeated) due to a payment failure caused by a failure to find a transaction order when construction of the transaction order is not completed and transaction payment is performed in advance based on a collected invalid biometric feature, can be resolved to some extent. It can be learned that the transaction data processing method as described herein can not only avoid repeated collection of the biometric feature, but also reduce a probability of repeated processing of transaction data in the transaction order when transaction payment is performed based on the biometric feature, thereby improving a completion rate of transaction payment.

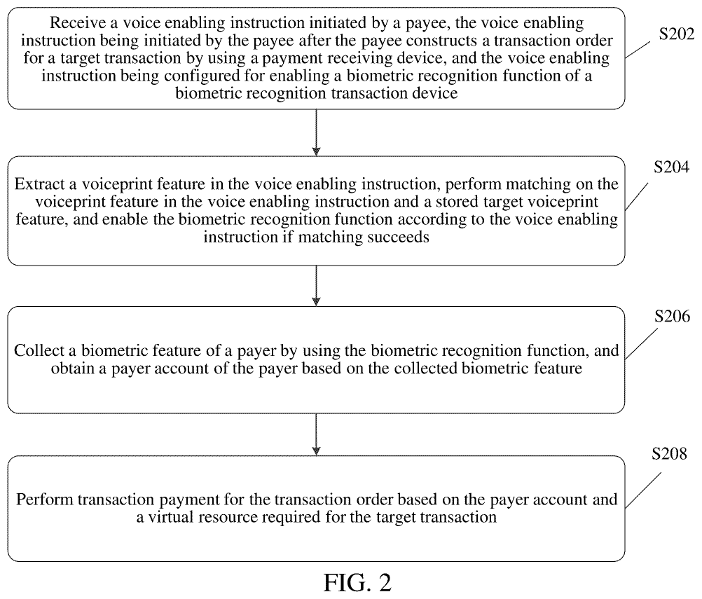

The following describes the transaction data processing method in aspects as described herein. Specifically, FIG. 2 is a schematic flowchart of a transaction data processing method according to an aspect as described herein. Although this application provides method operations in the aspect or flowchart of FIG. 2, more or fewer operations may be included based on routine or non-creative work. A sequence of the operations listed in this aspect as described herein is only one of a plurality of operation execution sequences, and does not indicate the only execution sequence. In practice, when performed by a system or server product, the method may be performed in the sequence of the method shown in the aspect or the flowchart, or performed in parallel (for example, in an environment of parallel processors or multithreaded processing). The transaction data processing method shown in FIG. 2 may be applied to terminal devices such as a computer, a tablet computer, and a smartphone. Certainly, the method may also be applied to a server according to an actual requirement. This is not specifically limited in this aspect as described herein.

Specifically, as shown in FIG. 2, the transaction data processing method may be applied to a biometric recognition transaction device. The biometric recognition transaction device herein may be the terminal 100 in the aspect corresponding to FIG. 1. The biometric recognition transaction device may be configured to perform unidirectional communication to a payment receiving device in an entire transaction data processing process, trigger biometric feature collection by using a voice enabling instruction in the transaction data processing process to recognize identity information of a payer based on a biometric feature, and further obtain a payer account of the payer based on the recognized identity information of the payer to perform transaction payment, based on the payer account and a virtual resource (for example, a transaction amount) required by a current transaction (that is, a target transaction), on a transaction order pre-created by the payment receiving device.

The biometric recognition transaction device may be configured to perform face recognition, fingerprint recognition, palm-scan recognition, voice recognition, and the like. This is not specifically limited in this aspect as described herein. The palm-scan recognition herein includes, but is not limited to, palmprint recognition and/or palm vein recognition on a payee. The transaction data processing method shown in FIG. 2 may include operation S202 to operation S208:

S202: Receive the voice enabling instruction of the payee.

The voice enabling instruction is initiated by the payee after the payee constructs the transaction order for the current transaction (that is, the target transaction) by using the payment receiving device. The voice enabling instruction may be configured for triggering the biometric recognition transaction device to enable or open a biometric recognition function. The payment receiving device herein is an electronic device that performs unidirectional communication to the biometric recognition transaction device.

In a specific implementation process, after a user makes a purchase, when transaction payment needs to be performed for a currently purchased commodity, a virtual resource (for example, a transaction amount) that the user needs to pay for the currently purchased commodity is a transaction. In this aspect as described herein, the transaction that the user currently needs to perform may be collectively referred to as the target transaction. In this way, the payee (for example, a cashier) may construct the transaction order for the target transaction by operating the payment receiving device. The transaction order may include transaction data information related to the target transaction, for example, related information of two parties (for example, the payee and the payer) of the transaction, and related information of a transaction object (for example, a transaction commodity, that is, the commodity purchased by the user). Specifically, the transaction order may include a name of the payee, an account of the payee (that is, a payee account), and a name, a price, a transaction time, and the like of the transaction commodity participating in the target transaction.

The payment receiving device may be a device that can construct a transaction order and complete transaction payment. Transaction payment completion in this aspect as described herein means that the payment receiving device currently successfully receives the virtual resource transferred from the payer account of the payer to the payee account of the payee.

For example, the payment receiving device may be a point of sales (POS) machine or another payment receiving device in a shopping mall or a supermarket. A type of the payment receiving device is not specifically limited in this aspect as described herein. After the payee constructs the transaction order by using the payment receiving device, it indicates that the payment receiving device currently enters a state in which payment can be received. The state in which payment can be received may be configured for representing that the payment receiving device is currently ready and can receive the virtual resource transferred by the biometric recognition transaction device when the biometric recognition transaction device performs transaction payment based on the biometric feature. It means that in this case, the payee may initiate the voice enabling instruction to the biometric recognition transaction device in a voice manner, to perform, based on the biometric feature extracted from the voice enabling instruction, a payment operation on the currently constructed transaction order.

Specifically, the payee may initiate the voice enabling instruction to the biometric recognition transaction device. The voice enabling instruction may be configured for triggering the biometric recognition transaction device to enable or open the biometric recognition function, so that the biometric recognition transaction device switches a working status for the biometric recognition function from a disabled state to an enabled state. In other words, usually, the biometric recognition function of the biometric recognition transaction device is disabled, that is, the working status of the biometric recognition transaction device for the biometric recognition function is the disabled state. In this way, after the payee enables the biometric recognition function of the biometric recognition transaction device by using the voice enabling instruction (that is, the payee triggers, by using the voice enabling instruction, the biometric recognition transaction device to switch the working status for the biometric recognition function from the disabled state to the enabled state), the biometric recognition transaction device may collect and recognize a biometric feature by using the enabled biometric recognition function.

Specific content of voice data carried in the voice enabling instruction may be set according to an actual requirement. For example, the specific content of the voice data may be “please scan your palm”, “please scan your face”, “enable a scanning function”, and the like. The specific content of the voice data carried in the voice enabling instruction is not specifically limited in this aspect as described herein.

In addition, the payment receiving device and the biometric recognition transaction device in this aspect as described herein perform unidirectional communication, that is, the biometric recognition transaction device can transmit information to the payment receiving device, but the payment receiving device cannot transmit information to the biometric recognition transaction device. Usually, the payment receiving device and the biometric recognition transaction device in this aspect as described herein belong to different parties, and the parties may be understood as owners, managers, producers, or researchers of the devices. A party to which the payment receiving device belongs is usually a merchant, for example, a supermarket, and a party to which the biometric recognition transaction device belongs is usually a platform corresponding to the payer account of the payer, for example, a financial institution or a mobile payment platform. Because the payment receiving device and the biometric recognition transaction device belong to different parties, the payment receiving device and the biometric recognition transaction device have some technical barrages, and usually cannot perform bidirectional communication. To implement bidirectional communication, the two parties need to cooperate to perform technical modifications, which makes operations difficult. Therefore, when the payment receiving device and the biometric recognition transaction device perform unidirectional communication, it is difficult for the biometric recognition transaction device to learn whether the payment receiving device currently completes construction of the transaction order, so that when the payment receiving device does not complete construction of the transaction order, the biometric recognition transaction device may collect a biometric feature, causing a transaction payment failure. Based on this, in this aspect as described herein, when the payment receiving device and the biometric recognition transaction device perform unidirectional communication, after creating the transaction order at the payment receiving terminal, the payee transmits the voice enabling instruction to the biometric recognition transaction device in the voice manner. In this way, the biometric recognition transaction device may trigger enabling of the biometric recognition function based on the currently received voice enabling instruction, to collect or extract, by using the currently enabled biometric recognition function, the biometric feature of the payer from a target image captured for biometric recognition. This can fundamentally avoid a transaction payment failure caused by an inappropriate collection occasion of the biometric feature (for example, collecting the biometric feature in advance when construction of the transaction order is not completed) in the entire transaction data processing process, thereby avoiding phenomena that the order needs to be re-constructed, the biometric feature needs to be re-collected, and transaction payment needs to be repeatedly performed.

S204: Extract a voiceprint feature in the voice enabling instruction, perform matching on the voiceprint feature in the voice enabling instruction and a stored target voiceprint feature, and enable a biometric recognition function according to the voice enabling instruction if matching succeeds.

In a specific implementation process, after the voice enabling instruction initiated by the payee (for example, a cashier A) is received, voice data of the payee (for example, the cashier A) may be obtained from audio data carried in the voice enabling instruction, to extract a voiceprint feature of the payee (for example, the cashier A) from the voice data of the payee (for example, the cashier A), and perform matching on the extracted voiceprint feature and the prestored target voiceprint feature of an authorized party (that is, a target party on which voiceprint registration has been performed). If matching succeeds, it is determined that the payee (for example, the cashier A) currently initiating the voice enabling instruction is an authorized party whose voiceprint has been successfully registered on the biometric recognition transaction device in advance. Further, the corresponding biometric recognition function (for example, a palm-scan recognition function corresponding to a palm-scan module, where the palm-scan recognition function herein may specifically include, but is not limited to, a palmprint recognition function and a palm vein recognition function) may be enabled based on specific content (for example, voice text content such as “please scan your palm”) of the voice data of the payee (for example, the cashier A) carried in the voice enabling instruction.

The authorized party herein refers to a party that is allowed to control the biometric recognition transaction device by using the voice enabling instruction. In this aspect as described herein, when receiving the voice enabling instruction initiated by the payee (for example, the cashier A), the biometric recognition transaction device may quickly determine, based on the voiceprint feature of the payee (for example, the cashier A) carried in the voice enabling instruction and the target biometric feature of the authorized party prestored in the biometric recognition transaction device, whether the payee of the currently initiated voice enabling instruction is the authorized party. If the payee of the currently initiated voice enabling instruction is the authorized party, enabling of the biometric recognition function of the biometric recognition transaction device may be triggered based on the specific content (that is, the voice text content) of the voice data carried in the voice enabling instruction.

The target voiceprint feature may be a voiceprint feature of the authorized party (that is, an authorized user such as the cashier A) that is allowed to use the voice enabling instruction to control the biometric recognition transaction device to enable the biometric recognition function. To ensure efficiency of voiceprint matching, in this aspect as described herein, voiceprint registration may be performed on the voiceprint feature of the payee (for example, the cashier A) in advance by using the biometric recognition transaction device. In this way, when voiceprint registration succeeds, the payee after voiceprint registration is used as the authorized party, a pre-collected voiceprint feature of the authorized party (for example, the authorized user) that is allowed to control the biometric recognition transaction device may be used as the target voiceprint feature, and the target voiceprint feature is stored in the biometric recognition transaction device, so that when a voice enabling instruction initiated by the cashier A is subsequently received in the biometric recognition transaction device, voiceprint matching may be quickly performed based on the voiceprint feature (for example, the target voiceprint feature) prestored in the biometric recognition transaction device. For example, in this aspect as described herein, whether the target voiceprint feature matching the voiceprint feature currently extracted from the voice enabling instruction exists in the voiceprint recognition transaction device can be quickly searched.

For example, when a biometric recognition transaction device used in a supermarket uses a biometric recognition payment receiving technology, voice sample data of one or more payees in the supermarket may be collected in advance by using the biometric recognition transaction device, and a voiceprint feature of each payee may be extracted from the collected voice sample data of the payees. For ease of understanding, in this aspect as described herein, an example in which payees on which voiceprint registration needs to be performed in the supermarket include a cashier A and a cashier B is used to describe a specific process of performing voiceprint registration on the cashier A and the cashier B in advance.

For example, the biometric recognition transaction device may collect voice sample data of the cashier A by using the biometric recognition payment receiving technology, and collect (that is, extract) a voiceprint feature of the cashier A from the collected voice sample data of the cashier A, so that the collected voiceprint feature of the cashier A may be used as a target voiceprint feature in the biometric recognition transaction device, and therefore voiceprint registration is completed on the cashier A when voiceprint storage is performed on the target voiceprint feature. In this case, the cashier A on which voiceprint registration is performed in the biometric recognition transaction device is an authorized party (that is, a target party on which voiceprint registration has been performed). Similarly, the biometric recognition transaction device may also collect voice sample data (that is, another piece of voice sample data) of another cashier (for example, the cashier B) by using the biometric recognition payment receiving technology, to collect (that is, extract) a voiceprint feature of the cashier B from the collected another piece of voice sample data of the cashier B, so that the collected voiceprint feature of the cashier B may be used as another target voiceprint feature in the biometric recognition transaction device, and therefore voiceprint registration is completed on the cashier B when voiceprint storage is performed on the another target voiceprint feature. In this case, the cashier B on which voiceprint registration is performed in the biometric recognition transaction device is also an authorized party (that is, a target party on which voiceprint registration has been performed).

In this way, subsequently, when a payee (for example, the cashier A and/or the cashier B) initiates a voice enabling instruction, whether the payee currently initiating the voice enabling instruction is an authorized party may be quickly determined based on the target voiceprint feature prestored in the biometric recognition transaction device. If the payee currently initiating the voice enabling instruction is an authorized party, enabling of a biometric recognition function may be triggered based on specific content of voice data carried in the voice enabling instruction.

In other words, in this aspect as described herein, when performing voiceprint registration on the cashier A and/or the cashier B, the biometric recognition transaction device may collect a sample enabling instruction that is initiated by the cashier A and/or the cashier B and that is configured for controlling the biometric recognition transaction device to enable the biometric recognition function, further collect the voiceprint feature of the cashier A and/or the voiceprint feature of the cashier B from voice sample data carried in the collected sample enabling instruction, and prestore the collected voiceprint feature of the cashier A and/or voiceprint feature of the cashier B in the biometric recognition transaction device. Based on this, when the cashier A or the cashier B receives payment for a transaction by using a payment receiving device, the cashier A or the cashier B may first construct a transaction order for the transaction on the payment receiving device, and then initiate a voice enabling instruction to the biometric recognition transaction device in a voice manner. In this way, the biometric recognition transaction device may intelligently control, based on the received voice enabling instruction initiated by a payee (for example, the cashier A or the cashier B), the biometric recognition transaction device to enable the biometric recognition function.

In this aspect as described herein, the voice data carried in the voice enabling instruction initiated by the payee is a voice in audio data transmitted by the payee to the biometric recognition transaction device after the payee creates the transaction order, and the voice sample data carried in the sample enabling instruction initiated by the payee is a voice in audio data transmitted by the payee to the biometric recognition transaction device when the payee performs voiceprint registration. In other words, the voice enabling instruction and the sample enabling instruction herein are instructions that are initiated by a same payee to the biometric recognition transaction device at different moments and that are configured for triggering enabling of the biometric recognition function.

Certainly, before extracting the voiceprint feature, the biometric recognition transaction device may further perform preprocessing such as denoising on audio data corresponding to a voice signal in the received voice enabling instruction, to improve accuracy of collecting the voiceprint feature from the audio data.

S206: Collect the biometric feature of the payer by using the biometric recognition function, and obtain a payer account of the payer based on the collected biometric feature.

In a specific implementation process, after the biometric recognition function is enabled, the working status of the biometric recognition transaction device for the biometric recognition function is switched from the disabled state to the enabled state. It means that in this case, the biometric recognition transaction device may enter a recognizable state when the working status is the enabled state, and may further collect or extract the biometric feature of the payer from the collected target image based on the recognizable state.

The payer may be understood as a paying party corresponding to the current transaction order. The biometric feature of the payer may specifically include a human face feature, a voice feature, a fingerprint feature, a palm feature, and the like. A specific biometric feature may be set according to an actual requirement, and is not specifically limited in this aspect as described herein. The human face feature refers to a feature extracted by the biometric recognition transaction device from the collected target image (for example, a human face image). The voice feature refers to a feature extracted by the biometric recognition transaction device from the collected target image (for example, a time-frequency spectrum image corresponding to voice data). The fingerprint feature refers to a feature extracted by the biometric recognition transaction device from the collected target image (for example, a fingerprint image). The palm feature refers to a feature extracted by the biometric recognition transaction device from the collected target image (for example, a palm image). The palm feature may specifically include a palmprint feature recognized and extracted from a palmprint image, a palm vein feature recognized and extracted from a palm vein image, and the like. The palmprint image and the palm vein image herein are palm images captured by the biometric recognition transaction device by using a photographing device.

After collecting the biometric feature of the payer by using the biometric recognition function, the biometric recognition transaction device may obtain the payer account of the payer based on the biometric feature. The payer account may be account information, payment code, or the like associated with the biometric feature of the payer. Specific content of the payer account may be adjusted according to an actual requirement, and is not specifically limited in this aspect as described herein.

In this aspect as described herein, before selecting to perform transaction payment through biometric recognition, the payer needs to bind the biometric feature of the payer to a specific account (for example, the payer account) in advance. Therefore, when collecting the biometric feature of the payer, the biometric recognition transaction device may obtain, based on the biometric feature, the pre-bound account information of the payer.

In addition, in some aspects, after enabling the biometric recognition function, the biometric recognition transaction device may send prompt information to the payer. For example, a light of a recognition region of the biometric recognition transaction device flashes or changes, or the biometric recognition transaction device directly transmits a voice prompt, to facilitate the payer to perform a corresponding payment operation based on the prompt information transmitted by the biometric recognition transaction device. In this case, the biometric recognition transaction device may perform, based on the payment operation (for example, a palm-scan operation) performed by the payer, scanning to obtain the target image for biometric recognition, to perform biometric feature collection on the target image obtained through scanning.

S208: Perform transaction payment on the transaction order based on the payer account and the virtual resource required for the target transaction.

In a specific implementation process, after obtaining the payer account of the payer, the biometric recognition transaction device may complete transaction payment based on the payer account and the virtual resource required for the target transaction in the transaction order. For example, the biometric recognition transaction device may transfer the virtual resource from the payer account to the payee account of the payee based on the virtual resource that is recorded in the transaction order and that is required for payment for the target transaction.

In some aspects, in another implementation, the biometric recognition transaction device may alternatively return (that is, unidirectionally transmit) the payer account to the payment receiving device after obtaining the payer account of the payer, so that the payment receiving device receives, within preset transaction payment duration, transaction payment from the payer account based on the virtual resource required for the target transaction. In this way, because the biometric recognition transaction device and the payment receiving device perform unidirectional communication, to ensure that the biometric recognition transaction device can intelligently disable the biometric recognition function after transaction payment is completed, the biometric recognition transaction device may record account returning duration corresponding to the payer account after returning the payer account to the payment receiving device, further confirm, when the recorded account returning duration reaches the preset transaction payment duration, that transaction payment for the transaction order is completed, and further intelligently trigger disabling of the biometric recognition function, to avoid a phenomenon that another user scans an invalid biometric feature in advance when the payment receiving device has not completed construction of another transaction order, resulting in a transaction payment failure of the another transaction order.

In some aspects, in this aspect as described herein, when operation S208 is performed, after transaction payment is performed for the transaction order, the biometric recognition function may be further disabled. For example, in this aspect as described herein, the biometric recognition function may be disabled when transaction payment succeeds, to reset the working status of the biometric recognition transaction device from the enabled state to the disabled state. In this way, after subsequently completing creation of a transaction order for another transaction by using the payment receiving device, the payee may initiate a new voice enabling instruction to the biometric recognition transaction device in the voice manner. It means that when receiving the new voice enabling instruction, the biometric recognition transaction device may perform matching on a voiceprint feature in the new voice enabling instruction and the stored target voiceprint feature, and further re-enable the biometric recognition function according to the new voice enabling instruction when matching succeeds, to collect, by using the re-enabled biometric recognition function, a biometric feature of a payer needing to pay for the current transaction order. For a specific implementation in which the biometric recognition transaction device performs feature extraction and feature matching on the voiceprint feature in the new voice enabling instruction, refer to specific descriptions of operation S202 to operation S204. A specific implementation of controlling, in the voice manner, the biometric recognition transaction device to enable the biometric recognition function is not described herein.

In this aspect as described herein, the biometric recognition transaction device may alternatively disable the biometric recognition function after transaction payment is performed on the transaction order and transaction payment is completed, to avoid a phenomenon that another user (that is, another payer) scans a biometric feature of the user (that is, the another payer) in advance when the payment receiving device has not completed construction of a new transaction order, resulting in a failure of another transaction in the transaction order. In addition, after transaction payment is completed, the biometric recognition transaction device intelligently disables the biometric recognition function and triggers enabling of the biometric recognition function only in a specific case, so that collection of an invalid biometric feature can be effectively avoided, thereby reducing a waste of transaction computing resources caused by transaction payment using the invalid biometric feature.

For example, if a user S (that is, the payer) goes shopping at a supermarket, and selects to use palm-scan payment when performing a checkout operation (that is, the payment operation) at a checkout counter. Then, after a cashier B (that is, the payee) settles a commodity (that is, the transaction commodity) purchased by the user S, the cashier B may construct a transaction order for a current transaction (that is, the target transaction) by using the payment receiving device. For example, transaction information in the transaction order may specifically include a payee account of the supermarket in which the cashier B is located and a virtual resource (for example, a resource amount of the virtual resource may be 100 yuan) required for paying the target transaction. Based on this, after the cashier B constructs the transaction order by using the payment receiving device, the cashier B may transmit a voice enabling instruction to the biometric recognition transaction device. For example, voice text content corresponding to a piece of voice data is a voice instruction “please scan your palm”. In this case, after receiving the voice enabling instruction, the biometric recognition transaction device extracts a voiceprint feature of the payee from the voice data carried in the voice enabling instruction, performs matching on the extracted voiceprint feature of the payee and the prestored target voiceprint feature, and confirms, after matching succeeds, that the cashier B is an authorized party that is allowed to control the biometric recognition transaction device. In this case, the biometric recognition transaction device may further enable the biometric recognition function based on the voice enabling instruction and transmit prompt information to the payer, so that the user S may place a palm of the user S in a collection region of the biometric recognition transaction device based on the prompt information. In this way, the biometric recognition transaction device may extract a biometric feature of the user S, for example, a palmprint feature of the user S, from a target image collected in the collection region, and further search, based on the collected biometric feature (for example, the palmprint feature of the user S), for a payer account of the user S that is bound to the palmprint feature of the user S in advance. Then, further, the biometric recognition transaction device may transfer 100 yuan from the payer account of the user S to the payee account of the supermarket. In some aspects, in another implementation, the biometric recognition transaction device may alternatively transmit the obtained payer account of the user S to the payment receiving device, and the payment receiving device receives payment. For example, the biometric recognition transaction device may return obtained payment code of the user S to the payment receiving device, and then the payment receiving device may transfer, based on the currently received payment code of the user S, 100 yuan from the payer account of the user S associated with the payment code to a payee account of the payment receiving device, to complete transaction payment for the transaction order. Further, the biometric recognition transaction device in this aspect as described herein may further intelligently disable the biometric recognition function of the biometric recognition transaction device after transaction payment is completed. In this case, even if the user performs a palm-scan operation, the biometric feature of the user is not collected, and naturally, a data processing process of another transaction is not affected.

This aspect as described herein provides the transaction data processing method. After the payee completes construction of the transaction order by using the payment receiving device, the payee may initiate the voice enabling instruction to the biometric recognition transaction device. In this way, when receiving the voice enabling instruction initiated by the payee, the biometric recognition transaction device may further extract the voice data carried in the voice enabling instruction, to recognize the voiceprint feature of the payee from the voice data, and further perform matching (that is, perform voiceprint feature matching) on the voiceprint feature extracted from the voice enabling instruction and the pre-collected and stored target voiceprint feature, to recognize whether an identity of the payee is an authorized party that can control the biometric recognition transaction device. For example, in this aspect as described herein, after voiceprint feature matching succeeds, it may be determined that the payee is an authorized party. Therefore, enabling of the biometric recognition function of the biometric recognition transaction device may be triggered, so that the biometric feature of the payer may be further collected by using the enabled biometric recognition function, the payer account of the payer that is bound in advance may be obtained based on the collected biometric feature, and further transaction payment for the transaction order is completed based on the payer account of the payer and the virtual resource corresponding to the target transaction. Based on this, after completing transaction payment, the biometric recognition transaction device may further disable the biometric recognition function. In this way, it can be ensured that enabling of the biometric recognition function of the biometric recognition transaction device can be triggered in the voice manner only after the payment receiving device completes creation of a transaction order. In this way, not only ineffective collection of a biometric feature can be avoided, but also an effective collection rate of a biometric feature can be improved. In addition, in this aspect as described herein, when transaction payment is performed for the transaction order, transaction payment for the transaction order may be completed at once. It means that in the entire transaction data processing process of performing transaction payment for the transaction order, the biometric feature of the payer does not need to be repeatedly scanned, so that a probability of repeated processing when transaction payment is performed through biometric recognition can be reduced, thereby improving transaction processing efficiency and transaction completion efficiency in a transaction payment process. Then, in this aspect as described herein, after verification and payment are completed for the current transaction order, the biometric recognition function of the biometric recognition transaction device is disabled, so that within other time after the transaction is completed, even if the biometric feature of the payer is scanned, the currently scanned biometric feature is considered as an invalid biometric feature, and therefore subsequent processing of another transaction order is not affected. In this way, problems of a transaction failure and invalid biometric feature collection that are caused by incorrect scanning time of the biometric feature can be avoided. Finally, in this aspect as described herein, enabling of the biometric recognition function is triggered in the voice manner, so that the payment receiving device and the biometric recognition transaction device do not need to perform bidirectional communication. It means that when the biometric recognition transaction device performs unidirectional communication to the payment receiving device, technical modification does not need to be performed on the payment receiving device, and the biometric recognition function can still be intelligently enabled and disabled to improve transaction processing efficiency when the currently available biometric recognition transaction device continues to be used to perform transaction payment. In this way, modification costs of technical modification on the payment receiving device can be reduced to some extent.

In this aspect as described herein, a specific process in which the biometric recognition transaction device receives the voice enabling instruction initiated by the payee may be described as follows: The biometric recognition transaction device may collect voice data by using a microphone array disposed in the biometric recognition transaction device, and determine, based on the microphone array, a sound source position and a sound source direction that correspond to the collected voice data. Further, the biometric recognition transaction device may determine, from the voice data based on the sound source position and the sound source direction that correspond to the voice data, target voice data corresponding to a position of the payee. Further, the biometric recognition transaction device may use the target voice data as the voice enabling instruction.

In a specific implementation process, in this aspect as described herein, the microphone array may be disposed in the biometric recognition transaction device, and voice data in proximity range space of the biometric recognition transaction device may be collected (or captured) by using the microphone array. In this aspect as described herein, there may be one or more pieces of voice data collected in the proximity range space of the biometric recognition transaction device, and a specific quantity of pieces of collected voice data is not limited herein. Further, the biometric recognition transaction device may determine, based on the microphone array, a sound source position and a sound source direction that correspond to each piece of voice data collected in the proximity range space, further determine, from the sound source position and the sound source direction that correspond to the voice data, the target voice data corresponding to the position of the payee that currently uses the payment receiving device to receive payment, and further use the target voice data as the voice enabling instruction received by the biometric recognition transaction device and initiated by the payee.

The position of the payee may be a sound source position in a specified sound source direction (for example, a sound source direction of the payment receiving terminal) that is preset in the proximity range space of the biometric recognition transaction device.

The microphone array is obtained by arranging a specific quantity of microphones in a preset arrangement and distribution manner. In other words, the microphone array herein usually includes a specific quantity of acoustic sensors (usually microphones), and may be configured for sampling and processing a spatial feature of a sound field (for example, in the proximity range space of the biometric recognition transaction device). Specifically, in this aspect as described herein, the microphone array may be used to collect all voice data in environmental space (for example, the proximity range space of the biometric recognition transaction device) in which the biometric recognition transaction device is located, and a phase and amplitude difference between sound waveforms of voice data received by microphones in the microphone array are used to perform analysis and calculation by using a signal processing algorithm to determine the sound source position and the sound source direction that correspond to each piece of collected voice data, thereby implementing directional collection of a sound source. Then, in this aspect as described herein, based on the determined sound source position and sound source direction that correspond to the voice data, whether voice data corresponding to the position of the payee of the payment receiving device exists in the voice data may be determined. If the voice data corresponding to the position of the payee of the payment receiving device exists in the voice data, the voice data corresponding to the position of the payee is used as the target voice data, and further the target voice data may be used as the voice enabling instruction initiated by the payee.

Usually, the payee receives payment at a position of the payment receiving device, and the biometric recognition transaction device is usually fixedly disposed near the payment receiving device. Therefore, a position of the payee relative to the biometric recognition transaction device is fixed. Therefore, in this aspect as described herein, the microphone array may be used to determine, from the collected and recognized voice data, the sound source position and the sound source direction that correspond to each piece of voice data, to quickly locate, from the determined sound source position and sound source direction that correspond to each piece of voice data, which piece of voice data is transmitted by the payee, so that the voice enabling instruction transmitted by the payee can be accurately collected and recognized, and further enabling of the biometric recognition function of the biometric recognition transaction device may be triggered according to the collected voice enabling instruction. In this way, accuracy of enabling the biometric recognition function of the biometric recognition transaction device can be effectively improved. In this aspect as described herein, a sound source position corresponding to one piece of voice data may be configured for representing a distance position between a sound source corresponding to the voice data and the biometric recognition transaction device, and a sound source direction corresponding to one piece of voice data may be configured for representing an orientation, relative to the biometric recognition transaction device, of a sound source corresponding to the voice data at the sound source position.

The biometric recognition transaction device in this aspect as described herein may be particularly deployed in some noisy scenarios. It means that a large amount of voice data may exist in an environment in which the biometric recognition transaction device is located. Therefore, when the microphone array deployed in the biometric recognition transaction device is used to directionally collect the sound source of the extracted voice data, not only accuracy of voice enabling instruction collection can be effectively improved, but also a signal-to-noise ratio and definition of a voice signal corresponding to each piece of collected audio data can be improved, thereby reducing interference of ambient noise to some extent.

In some aspects, extracting the voiceprint feature in the voice enabling instruction, performing matching on the voiceprint feature in the voice enabling instruction and the stored target voiceprint feature, and enabling the biometric recognition function according to the voice enabling instruction if matching succeeds includes:
extracting a voiceprint feature vector corresponding to each frame of voice signal in the voice enabling instruction;
concatenating extracted voiceprint feature vectors in chronological order, to obtain a voiceprint feature sequence; and
inputting the voiceprint feature sequence into a pre-trained voiceprint recognition model, calculating a matching probability between the voiceprint feature sequence and each target voiceprint feature by using the voiceprint recognition model, and if a matching probability between the voiceprint feature sequence and at least one target voiceprint feature is greater than a preset threshold, determining that matching succeeds, and enabling the biometric recognition function according to the voice enabling instruction, the voiceprint recognition model being constructed through training based on the target voiceprint feature.

In a specific implementation process, the target voiceprint feature may be used for training to construct the voiceprint recognition model, so that the trained voiceprint recognition model may be stored in the biometric recognition transaction device. In this way, after receiving the voice enabling instruction, the biometric recognition transaction device may divide audio data carried in the voice enabling instruction into a plurality of voice frames, to extract a voiceprint feature vector corresponding to a voice signal of each voice frame, and concatenate the extracted voiceprint feature vectors in chronological order, to obtain the voiceprint feature sequence. One voice frame may usually include a voice signal of 20 milliseconds to 30 milliseconds. Therefore, for the voice signal of each voice frame, an algorithm such as Mel-frequency cepstral coefficient (MFCC) may be used to extract a feature (for example, a Gaussian distribution feature) of the voice signal of each voice frame, to use the extracted feature (for example, the Gaussian distribution feature) of the voice signal of each voice frame as the voiceprint feature vector corresponding to the voice signal of each voice frame.

Further, the biometric recognition transaction device may input the obtained voiceprint feature sequence into the pre-trained voiceprint recognition model, to automatically calculate, by using the pre-trained voiceprint recognition model, the matching probability between the voiceprint feature sequence and the target voiceprint feature used to train the voiceprint recognition model. In this aspect as described herein, when determining, by using the voiceprint recognition model, that the matching probability between the voiceprint feature sequence and the at least one target voiceprint feature is greater than the preset threshold, the biometric recognition transaction device determines that the voiceprint feature in the voice enabling instruction successfully matches the at least one target voiceprint feature. Therefore, in the at least one matched target voiceprint feature, a target voiceprint feature with a maximum matching probability is used as a target voiceprint feature matching the voiceprint feature in the voice enabling instruction, and the biometric recognition function is enabled according to the voice enabling instruction. A value of the preset threshold may be set according to an actual requirement. This is not specifically limited in this aspect as described herein.

For example, in this aspect as described herein, a target voiceprint feature of a cashier A and a target voiceprint feature of a cashier B may be used as sample data in advance, and model training is performed on an initial voiceprint recognition model (for example, a Gaussian mixture model) by using the sample data (for example, a voiceprint feature sequence formed by the pre-obtained target voiceprint features may be modeled by using the Gaussian mixture model), to construct (that is, model) a final voiceprint recognition model based on the trained initial voiceprint recognition model, and store the voiceprint recognition model obtained through modeling in the biometric recognition transaction device. Further, after receiving the voice enabling instruction, the biometric recognition transaction device may extract the voiceprint feature vectors in the voice enabling instruction, construct the voiceprint feature sequence based on the voiceprint feature vectors, and further input the voiceprint feature sequence into the currently trained voiceprint recognition model. The voiceprint recognition model calculates matching probabilities between the input voiceprint feature sequence and the target voiceprint feature of the cashier A and the target voiceprint feature of the cashier B. If it is determined through calculation that a matching probability between the input voiceprint feature sequence and the target voiceprint feature of the cashier A is greater than the preset threshold, it is determined that a voiceprint feature in the voice enabling instruction successfully matches the target voiceprint feature of the cashier A, that is, the voice enabling instruction is initiated by the cashier A. In this case, the biometric recognition function of the biometric recognition transaction device may be enabled based on the voice enabling instruction initiated by the cashier A.

It can be learned that, when the biometric recognition transaction device is a palm-scan device, the payment receiving device is a POS machine, and a communication mode between the palm-scan device and the POS machine is a human interface device (HID) mode (that is, a communication mode in which unidirectional communication is performed by simulating a conventional keyboard input), to avoid a phenomenon that the user (that is, the payer) needs to perform transaction payment again because the POS machine is not ready for order placement and the user (that is, the payer) performs a palm-scan operation prematurely, causing an order query failure, this aspect as described herein provides that when unidirectional communication between the palm-scan device and the POS machine is maintained, in combination with the voiceprint feature in the voice enabling instruction initiated by the cashier, the palm-scan device is quickly triggered to enter a palm-scannable state (that is, when the working status for the biometric recognition function is the enabled state, for example, enter a working status configured for representing that the biometric recognition function of the palm-scan device is currently enabled), to prevent the user (that is, the payer) from affecting transaction payment efficiency of a currently existing transaction order of another user due to premature palm-scan. The transaction order of the another user is an order, of another transaction of the another user, created by the payment receiving terminal when the current user performs the palm-scan operation. In other words, in this aspect as described herein, after voiceprint recognition or voiceprint matching is performed on the voiceprint feature carried in the currently received voice enabling instruction, to determine an identity of the payee (for example, the cashier) that initiates the voice enabling instruction, the payee (for example, the cashier) may transmit, to the palm-scan device in the more convenient voice manner, the voice enabling instruction configured for representing that the payment receiving device (POS machine) has currently created a transaction order and the palm-scannable state needs to be entered, so that the palm-scan device may trigger enabling of the biometric recognition function according to the voice enabling instruction, to avoid a phenomenon that the user (that is, the payer) fails to perform palm-scan because the transaction order is not ready.

In addition, in this aspect as described herein, before voiceprint matching is performed on the voiceprint feature in the voice enabling instruction by using the voiceprint recognition model, a target voiceprint feature of each authorized party collected by the biometric recognition transaction device may be first modeled by using the initial voiceprint recognition model (for example, the Gaussian mixture model). For example, model training may be first performed on the initial voiceprint recognition model (for example, the Gaussian mixture model) based on a target voiceprint feature of an authorized party that is allowed to control the biometric recognition function of the biometric recognition transaction device, to construct, in a manner of model training, a voiceprint recognition model configured for recognizing and predictively outputting a probability distribution of a voiceprint feature of each payee. Based on this, after receiving the voice enabling instruction initiated by the payee, the biometric recognition transaction device may calculate, by using the pre-trained voiceprint recognition model, the matching probability between the voiceprint feature in the voice enabling instruction and the target voiceprint feature used during model training, to implement identity authentication on the payee (for example, a cashier or a payment receiving user) that initiates the voice enabling instruction, and further ensure accurate enabling of the biometric recognition function of the biometric recognition transaction device when identity authentication succeeds, thereby facilitating data processing of subsequent transaction payment.

A specific method for constructing the voiceprint recognition model in this aspect as described herein may include the following operations: The biometric recognition transaction device may obtain a plurality of pieces of voice sample data configured for training the initial voiceprint recognition model (for example, the Gaussian mixture model), divide each of the plurality of pieces of voice sample data into a plurality of voice frames, and use extracted voiceprint feature vectors corresponding to voice signals of the plurality of voice frames in each piece of voice sample data as sample voiceprint feature vectors corresponding to the voice signals in each piece of voice sample data, each piece of voice sample data being voice data that is collected by the biometric recognition transaction device and that is of a target party authorized to enable the biometric recognition function. In this aspect as described herein, when each payee performs voiceprint registration by using the biometric recognition transaction device, the biometric recognition transaction device may obtain voice data submitted by each payee, and use the obtained voice data submitted by each payee as voice sample data subsequently configured for training the Gaussian mixture model, so that each piece of voice sample data may be divided into several voice frames with a preset frame quantity, to ensure that each of the several voice frames obtained through division includes a voice signal with preset duration (for example, 20 milliseconds to 30 milliseconds). In this way, the biometric recognition transaction device may extract, for any of the plurality of pieces of voice sample data, features of voice signals of a plurality of voice frames in the voice sample data, so that the extracted features of the voice signals of the plurality of voice frames may be collectively referred to as sample voiceprint feature vectors corresponding to the voice signals in the voice sample data, that is, a voice signal of one voice frame may correspond to one sample voiceprint feature vector. Based on this, further, the biometric recognition transaction device may concatenate, in chronological order, the extracted sample voiceprint feature vectors corresponding to the voice signals in each piece of voice sample data, to obtain (that is, obtain through concatenation) a sample voiceprint feature sequence corresponding to each piece of voice sample data, and use the sample voiceprint feature sequence obtained through concatenation as the target voiceprint feature. Further, the biometric recognition transaction device may extract a probability distribution of the target voiceprint feature by using the Gaussian mixture model, to perform model training on the Gaussian mixture model by using the extracted probability distribution of the target voiceprint feature, and use the Gaussian mixture model after model training as the constructed voiceprint recognition model. The voiceprint recognition model includes a plurality of voiceprint recognition sub-models, and each voiceprint recognition sub-model may correspond to a Gaussian distribution of one target voiceprint feature. In other words, each voiceprint recognition sub-model is constructed for a Gaussian distribution of a target voiceprint feature of one payee.

In a specific implementation process, voice data of a target party that is allowed to enable the biometric recognition function of the biometric recognition transaction device may be first collected as voice sample data. In an implementation, the voice sample data herein may include voice data in a voice enabling instruction initiated by a payee used for performing voiceprint registration. Certainly, in some aspects, in this aspect as described herein, other collected voice data of the target party (that is, the authorized party) on which voiceprint registration has been performed may also be used as voice sample data in a process of training the Gaussian mixture model to finally obtain the voiceprint recognition model. For example, voice data of different tones of a same payee may be collected as voice sample data, voice data of different volumes of a same payee may be collected as voice sample data, and voice data of different speeds and/or different pronunciations of a same payee may be collected as voice sample data. The collected voice sample data may all be configured for performing model training on the Gaussian mixture model. In this aspect as described herein, in a process of recording a voiceprint by using the biometric recognition transaction device, consistency and stability of an environment in which the biometric recognition transaction device performs voice collection on voice data corresponding to voice features in different dimensions can be ensured, to ensure that in a process of performing model training on the Gaussian mixture model by using the voice features in the different dimensions in the collected voice sample data, accuracy and reliability of model training can be improved.

For another example, when a same payee performs voiceprint registration by using the biometric recognition transaction device, the same payee may record, by using the biometric recognition transaction device, a segment of voice data that has a sample length of more than 10 seconds and that includes voice features in a plurality of different dimensions. The voice features in the plurality of different dimensions herein may include, but are not limited to, a voice feature in a tone dimension, a voice feature in a volume dimension, a voice feature in a speed dimension, and a voice feature in a pronunciation dimension.

Further, when one piece of voice sample data is divided into a plurality of voice frames, a voice signal of one voice frame may be one frame of voice signal. Therefore, in this aspect as described herein, feature extraction may be performed on each frame of voice signal in each piece of voice sample data, to extract a sample voiceprint feature vector of each frame of voice signal in each piece of voice sample data. Further, extracted sample voiceprint feature vectors may be concatenated in chronological order, to obtain a sample voiceprint feature sequence corresponding to each piece of voice sample data, and the sample voiceprint feature sequence may be used as the target voiceprint feature. Then, in this aspect as described herein, a probability distribution of the target voiceprint feature may be extracted by using the Gaussian mixture model, to perform model training on a Gaussian training model by using the extracted probability distribution of the target voiceprint feature, so that the Gaussian training model after training that is configured for accurately predicting a probability distribution of a voiceprint feature may be used as the constructed voiceprint recognition model.

The Gaussian mixture model may be understood as a probability statistical model. In this aspect as described herein, the voiceprint recognition model established through training by using the Gaussian mixture model may include a plurality of voiceprint recognition sub-models, and each voiceprint recognition sub-model may correspond to a Gaussian distribution of one target voiceprint feature. Further, when voiceprint recognition is subsequently performed by using the trained voiceprint recognition model including the plurality of voiceprint recognition sub-models, a matching probability between the voiceprint feature in the currently obtained voice enabling instruction and each voiceprint recognition sub-model may be calculated, that is, a matching probability between the voiceprint feature in the currently obtained voice enabling instruction and a target voiceprint feature in each voiceprint recognition sub-model may be calculated. In this aspect as described herein, the voiceprint recognition model is constructed through training by using the Gaussian model, so that voiceprint feature matching may be subsequently performed by using the trained voiceprint recognition model, to quickly determine whether the payee currently transmitting the voice enabling instruction is the target party (that is, the authorized party) on which voiceprint registration has been performed. If the payee currently transmitting the voice enabling instruction is the target party (that is, the authorized party) on which voiceprint registration has been performed, a pre-associated instruction function configured for enabling the biometric recognition function of the biometric recognition transaction device may be found by using an instruction function carried in the voice enabling instruction. Further, the biometric recognition function may be quickly enabled by searching for the instruction function, to quickly and accurately collect a valid biometric feature of the payer. Further, transaction payment may be performed by using the collected valid voiceprint feature, to improve transaction processing efficiency in the transaction payment process.

In addition, in this aspect as described herein, the biometric recognition transaction device not only can be controlled by using the voice enabling instruction to enable the biometric recognition function, but also can be controlled by using another voice instruction (for example, a voice query instruction) to perform another operation. Therefore, when the voiceprint recognition model is trained, voice sample data including different voice instructions may be collected, to construct, through training, a voiceprint recognition model capable of recognizing voiceprint features of different voice instructions. A training manner using a voiceprint feature of the another voice instruction is similar to a training manner using the voiceprint feature corresponding to the voice enabling instruction, and details are not described herein again.

In some aspects as described herein, before the biometric recognition transaction device receives the voice enabling instruction of the payee, the biometric recognition transaction device may further receive a voiceprint registration request initiated by the payee. The voiceprint registration request herein includes: voice sample data of the payee, a sample enabling instruction corresponding to the voice sample data (that is, the voice enabling instruction corresponding to the voice sample data carried in the voiceprint registration request), and an instruction function corresponding to the sample enabling instruction. The instruction function herein may include enabling the biometric recognition function of the biometric recognition transaction device. Further, the biometric recognition transaction device may extract a target voiceprint feature in the voice sample data, and store the target voiceprint feature (for example, may store the target voiceprint feature locally on the voiceprint recognition transaction device). Further, the biometric recognition transaction device may associate the sample enabling instruction with an operation corresponding to the instruction function configured for enabling the biometric recognition function of the biometric recognition transaction device. In this way, when subsequently obtaining the voice enabling instruction, the biometric recognition transaction device may quickly find, in a voiceprint matching manner, the sample enabling instruction having a same voiceprint feature as the voice enabling instruction, and further quickly find the instruction function associated with the sample enabling instruction, to intelligently and quickly trigger enabling of the biometric recognition function of the biometric recognition transaction device based on the found instruction function. The voice enabling instruction and the sample enabling instruction may both be voice instructions initiated by a same payee before and after voiceprint registration.

In a specific implementation process, before receiving the voice enabling instruction, the biometric recognition transaction device may first perform voiceprint registration, that is, the biometric recognition transaction device may first receive the voiceprint registration request submitted by the payee used for performing voiceprint registration. The voiceprint registration request herein may include the voice sample data, a voice instruction (that is, the sample enabling instruction), and an instruction function corresponding to the voice instruction (that is, the sample enabling instruction). The voiceprint registration request herein is usually initiated by a user that is allowed to control the biometric recognition transaction device, for example, the payee.

The voice instruction in this aspect as described herein may include the voice enabling instruction initiated by the payee and the sample enabling instruction initiated by the payee when voiceprint registration is performed in the foregoing aspect. The instruction function corresponding to the sample enabling instruction may be understood as performing a related operation (that is, a voice trigger operation) on the biometric recognition transaction device by using the voice instruction corresponding to the voice sample data. For example, the voice trigger operation herein may include triggering enabling of the biometric recognition function in the voice manner, triggering querying of a transaction record of the biometric recognition transaction device in the voice manner, or the like. The instruction function in this aspect as described herein may be a function that is set by the payee during voiceprint registration and that is for requesting to perform the related voice trigger operation.

Then, after receiving the voice registration request, the biometric recognition transaction device may obtain, from the voice registration request, the voice sample data recorded by the payee, further extract a target voiceprint feature from the voice sample data, and store the extracted target voiceprint feature. In this aspect as described herein, when each target voiceprint feature is stored, an identity identifier may be configured for each target voiceprint feature. The identity identifier may be configured for marking identity information of a payee corresponding to the target voiceprint feature, so that when the biometric recognition transaction device is subsequently controlled in the voice manner, identity authentication may be performed on a user initiating a voice instruction (for example, a voice enabling instruction). Identity authentication herein mainly means that whether the user currently initiating the voice instruction (for example, the voice enabling instruction) is a target party on which voiceprint registration has been performed may be determined. In addition, in this aspect as described herein, a target party on which identity registration has been performed may be collectively referred to as the authorized party. The authorized party has permission to trigger enabling of the biometric recognition function of the biometric recognition transaction device in the voice manner.

In addition, in this aspect as described herein, when each target voiceprint feature is stored, a voice instruction (sample voice instruction) initiated during voiceprint registration may be further associated with an instruction function. For example, the voice instruction (for example, the sample voice instruction) is “please scan your palm”, and the instruction function associated with the sample voice instruction may be enabling the biometric recognition function of the biometric recognition transaction device. In other words, in this aspect as described herein, during voiceprint registration, a voice instruction (for example, a sample enabling instruction) with voice text content such as “please scan your palm” may be associated with the instruction function for enabling the biometric recognition function of the biometric recognition transaction device. The sample enabling instruction may be an instruction corresponding to voice signals of a plurality of voice frames in the voice sample data, or may be a voice instruction specially recorded by the payee. For example, during voiceprint registration, the payee may record, by using the biometric recognition transaction device, voice data of “please scan your palm” said by the payee as voice sample data, and may set an instruction function corresponding to a voice instruction (for example, a sample voice instruction) corresponding to the voice sample data as enabling the biometric recognition function of the biometric recognition transaction device. In this way, when performing voiceprint storage on a target voiceprint feature extracted from the voice sample data, the biometric recognition transaction device may further associate an obtained sample enabling instruction with voice text content of “please scan your palm” with the currently set instruction function configured for enabling the biometric recognition function of the biometric recognition transaction device, for example, may establish an association relationship between the sample enabling instruction with the voice text content of “please scan your palm” and the preset instruction function. Based on this, after receiving a voice instruction (for example, the voice enabling instruction) of “please scan your palm”, the biometric recognition transaction device may perform voiceprint matching on the voiceprint feature in the voice enabling instruction and one or more prestored target voiceprint features, and further determine, based on the established association relationship after voiceprint matching succeeds, an instruction function associated with a sample enabling instruction corresponding to a currently matched target voiceprint feature, to perform an operation (that is, a voice trigger operation, for example, an enabling operation) of the instruction function associated with the voice instruction (for example, the sample enabling instruction), so that the biometric recognition transaction device can be intelligently controlled in the voice manner more conveniently and efficiently to enable the biometric recognition function of the biometric recognition transaction device.

Alternatively, in another implementation, in this aspect as described herein, during voiceprint registration, voice data of the payee speaking different utterances (for example, a voice feature of the payee in a tone dimension, a voice feature of the payee in a volume dimension, a voice feature of the payee in a speed dimension, and a voice feature of the payee in a pronunciation dimension) may be recorded by the biometric recognition transaction device as voice sample data, so that a voiceprint feature of the payee may be extracted from the recorded voice sample data as a target voiceprint feature. Then, when performing voiceprint storage on the extracted target voiceprint feature, the biometric recognition transaction device may associate a preset instruction function configured for enabling the biometric recognition function of the biometric recognition transaction device with a sample enabling instruction.

In some aspects, during voiceprint registration, the biometric recognition transaction device may also separately record voice data of a specified voice instruction (that is, the voice instruction such as “please scan your palm”) said by the payee, and may set an instruction function associated with the voice instruction. Then, when obtaining a voice instruction, the biometric recognition transaction device may recognize whether a voiceprint feature corresponding to the voice instruction matches the prestored target voiceprint feature of the payee, and if the voiceprint feature matches the prestored target voiceprint feature, associate the voice instruction with an operation corresponding to the set instruction function.

Certainly, the voice instruction in this aspect as described herein may include a voice enabling instruction, a voice query instruction, and the like. Different voice instructions may correspond to different instruction functions. As described herein, another voice instruction and a corresponding instruction function may be flexibly set according to an actual requirement, and the voice instruction is associated with the corresponding instruction function. For example, after a voice instruction of “please shut down” is recorded, the voice instruction of “please shut down” may be configured to be associated with a shutdown operation in a voice trigger operation, to control automatic shutdown of the biometric recognition transaction device in the voice manner. A type and a function of the voice instruction are not specifically limited in this aspect as described herein, and may be set according to an actual requirement.

For example, the voice instruction may further include an alarm setting instruction, a payment termination instruction, and the like. The alarm setting instruction may be configured for controlling the biometric recognition transaction device to set an alarm in the voice manner. In some working scenarios, a mobile phone is not allowed to be used, so that the biometric recognition transaction device may be controlled in the voice manner to set an alarm, and further the payee may be reminded, by using the set alarm, to instantly process a related matter. For example, the payee may be reminded to ship a good or send a delivery, or for some promotions in stores or supermarkets that start at a specified time, the alarm may remind the payee to adjust a payment receiving operation in time. For another example, the payment termination instruction may be configured for controlling, in a biometric feature recognition process when an error in an order is found or a user decides not to make the purchase, the biometric recognition transaction device in the voice manner to stop biometric feature recognition and transaction payment. If payment is completed, a payment termination operation may also be configured for controlling the biometric recognition transaction device in the voice manner to perform payment refund, to terminate or cancel the order for a current transaction (that is, a target transaction) in time. In this way, convenience and high efficiency of a related operation in the transaction payment process can be ensured.

In this aspect as described herein, the voice instruction may be associated with the specific functional operation through voiceprint registration. In addition, in this aspect as described herein, the voiceprint feature for executing the voice instruction may be further stored, so that after the voice instruction is received, identity recognition may be performed based on the voiceprint feature in the currently received voice instruction, and execution of an operation corresponding to the voice instruction is triggered after identity recognition succeeds, to more conveniently control the biometric recognition transaction device in the voice manner, thereby more conveniently processing transaction data in the transaction order.

In some aspects as described herein, the biometric recognition transaction device may further receive a voice query instruction. The voice query instruction may include a query time. Further, the biometric recognition transaction device may extract a voiceprint feature in the voice query instruction, perform matching on the voiceprint feature in the voice query instruction and the target voiceprint feature, and query, according to the voice query instruction if matching succeeds, transaction information of the biometric recognition transaction device within the query time.

In a specific implementation process, the voice instruction may be the voice query instruction. In this case, after receiving the voice query instruction, the biometric recognition transaction device may first recognize the voiceprint feature in the voice query instruction, and may perform matching on the voiceprint feature in the voice query instruction and the target voiceprint feature. If matching succeeds, the transaction information of the biometric recognition transaction device within the query time may be queried based on the query time in the voice query instruction. The voice query instruction may be configured for storing the corresponding voiceprint feature and associating the voice query instruction with a query operation in the voiceprint registration process. The transaction information may be understood as a transaction record, a transaction amount, or the like. The transaction amount may be a quantity of virtual resources of the target transaction that needs to be paid for by the payer.

In some aspects as described herein, the voice query instruction further includes an identity identifier of a to-be-queried payee. Therefore, a specific process in which the biometric recognition transaction device performs matching on the voiceprint feature in the voice query instruction and the target voiceprint feature, and queries, according to the voice query instruction if matching succeeds, the transaction information of the biometric recognition transaction device within the query time may be described as follows: The biometric recognition transaction device may perform matching on the voiceprint feature in the voice query instruction and the target voiceprint feature, and queries, according to the voice query instruction if matching succeeds, transaction information that is of the biometric recognition transaction device within the query time and that corresponds to the identity identifier.

In a specific implementation process, the voice query instruction might not only include the query time, but also include the identity identifier of the to-be-queried payee. The identity identifier may be configured for the voiceprint feature during voiceprint registration. In other words, the identity identifier is a unique identifier that can identify an identity of a payee (that is, a user) corresponding to the target voiceprint feature. Therefore, when receiving the voice query instruction, the biometric recognition transaction device may quickly obtain, based on the identity identifier in the voice query instruction, the target voiceprint feature corresponding to the identity identifier, further perform matching on the voiceprint feature extracted from the voice query instruction and the target voiceprint feature, and query, after matching succeeds, for the transaction information that is of the biometric recognition transaction device within the query time and that corresponds to the identity identifier, to obtain transaction information that is of the biometric recognition transaction device within the query time and that is of the to-be-queried payee corresponding to the identity identifier. The biometric recognition transaction device enables the biometric recognition function each time under control of a payee in the voice manner. Therefore, it means that processing of a transaction order of each piece of transaction data by the biometric recognition transaction device needs to correspond to one payee. Therefore, transaction information (for example, the virtual resource of the target transaction recorded in the transaction order and needing to be paid for by the payer) of a specified payee on the biometric recognition transaction device may be queried for based on an identity identifier by using a voice query instruction.

In addition, when the transaction information of the specified payee is queried for by using the voice query instruction, matching may be further performed on the identity identifier of the payee initiating the voice query instruction and identity identifier of the to-be-queried payee. Querying is allowed only after matching succeeds. In this way, it can be ensured that each payee can find, in the voice manner, transaction information in a transaction order currently created by the payee.

For example, after receiving the voice query instruction, the biometric recognition transaction device may obtain the voiceprint feature in the voice query instruction, and after matching on the voiceprint feature in the voice query instruction and the target voiceprint feature succeeds, obtain the identity identifier corresponding to the target voiceprint feature matching the voiceprint feature in the voice query instruction. As recorded in the foregoing aspect, each target voiceprint feature may correspond to one identity identifier that can identify a payee. Therefore, the biometric recognition transaction device may compare the identity identifier corresponding to the target voiceprint feature with the identity identifier of the to-be-queried payee in the voice query instruction. If the identity identifier corresponding to the target voiceprint feature is consistent with the identity identifier of the to-be-queried payee in the voice query instruction, querying of the transaction information may be performed. If the identity identifier corresponding to the target voiceprint feature is inconsistent with the identity identifier of the to-be-queried payee in the voice query instruction, it indicates that a payee corresponding to the target voiceprint feature is not the to-be-queried payee, and the payee is not allowed to query for the transaction information of the to-be-queried payee. In this way, security of transaction information of each payee that has performed transaction processing on a transaction order can be ensured.

Certainly, a manager of the payment receiving device may be usually allowed to query for transaction information of all payees, so that query permission of each payee may be set, for example, an identity identifier of each payee (that is, an identity identifier corresponding to each target voiceprint feature) may be associated with an identity identifier of a to-be-queried payee that is allowed to be queried by the manager, to control a query operation of the voice query instruction, thereby ensuring security of the transaction information.

According to the transaction data processing method provided in this aspect as described herein, the biometric recognition transaction device may be controlled in the voice manner to enable the biometric recognition function. In this way, a transaction failure caused because construction of a transaction order is not completed can be avoided, and transaction information of the biometric recognition transaction device within a specified time (that is, the specified query time) and/or transaction information of a specified payee on the biometric recognition transaction device can be queried for by using a voice, to ensure accuracy of the transaction information in the entire transaction payment process when verification is performed against transaction information on the payment receiving device.

In addition, target voiceprint features corresponding to different voice instructions may be separately stored in different voiceprint databases. When the biometric recognition transaction device is controlled by using a voice instruction to perform a corresponding operation (that is, a voice trigger operation), specific content of voice data in the voice instruction may be first extracted, and a corresponding voiceprint database may be found based on the voice instruction, to perform voiceprint matching on a voiceprint feature in the voice instruction and a voiceprint feature (that is, a target voiceprint feature) in the corresponding voiceprint database. For example, when performing voiceprint registration, a payee may separately store voiceprint features corresponding to different voice instructions by using the biometric recognition transaction device, so that when the biometric recognition transaction device is controlled by using a voice instruction, whether a user transmitting the instruction has function permission corresponding to the instruction can be more accurately recognized. For example, a cashier A can only control, in the voice manner, the biometric recognition transaction device to enable the biometric recognition function. Therefore, during voiceprint registration, a voiceprint feature when the cashier A initiates a voice enabling instruction may be stored in a voiceprint database 1. For another example, a cashier B is a manager, and can not only control, by using a voice, the biometric recognition transaction device to enable the biometric recognition function, but also query for transaction information of the biometric recognition transaction device. Therefore, when performing voiceprint registration, the cashier B may separately store a voiceprint feature of the cashier B in a voiceprint database 1 and a voiceprint database 2 by using the biometric recognition transaction device. Therefore, after receiving a voice instruction, the biometric recognition transaction device may first obtain specific content of voice data in the voice instruction, and determine, based on the specific content of the voice data in the voice instruction, whether to perform matching on a voiceprint feature corresponding to the voice instruction and a target voiceprint feature in the voiceprint database 1 or a target voiceprint feature in the voiceprint database 2. For example, if recognizing, based on the specific content of the voice data in the current voice instruction, that the current voice instruction is a voice enabling instruction, the biometric recognition transaction device may perform matching on the voiceprint feature corresponding to the voice instruction and the target voiceprint feature in the voiceprint database 1. Therefore, accuracy and security of controlling the biometric recognition transaction device by using the voice instruction are improved.

In some aspects as described herein, this application further provides a biometric recognition transaction device configured to process transaction data. The biometric recognition transaction device may specifically include: a voice collection module, a voiceprint instruction module, a biometric feature collection module, and a transaction service module.

The voice collection module may be configured to collect a voice enabling instruction of a payee. The voice enabling instruction is initiated by the payee after a payment receiving device constructs a transaction order for a target transaction, the voice enabling instruction is configured for enabling a biometric recognition function of the biometric recognition transaction device, and the biometric recognition transaction device is configured to perform unidirectional communication to the payment receiving device.

The voiceprint instruction module may be configured to perform voiceprint registration and associate the voice enabling instruction with a preset instruction function. The voice enabling instruction may be configured for enabling the biometric recognition function of the biometric recognition transaction device.

The biometric feature collection module may be configured to collect a biometric feature of a payer.

The transaction service module may be configured to: perform voiceprint recognition on the voice enabling instruction collected by the voice collection module, perform matching on a voiceprint feature in the voice enabling instruction and a stored target voiceprint feature, when matching succeeds, enable the biometric recognition function, and perform biometric recognition on the biometric feature collected by the biometric feature collection module, and when biometric recognition succeeds, obtain a payer account of the payer corresponding to the biometric feature, and perform transaction payment for the transaction order based on the payer account and a virtual resource required for the target transaction. In other words, in this aspect as described herein, after the biometric recognition function is enabled, the payer account of the payer corresponding to the biometric feature may be obtained through biometric recognition, and the transaction payment for the transaction order may be completed based on the payer account and transaction information (for example, the virtual resource required for payment of the target transaction) in the transaction order.

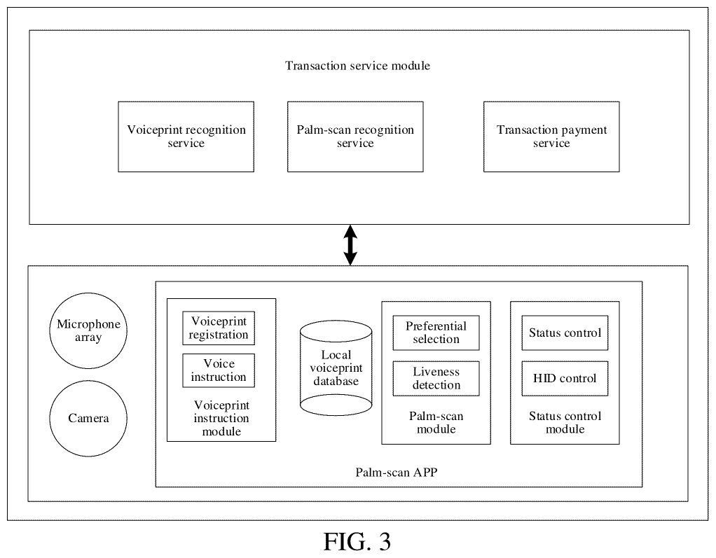

For a specific implementation process, refer to FIG. 3. FIG. 3 is a schematic diagram of a structure of a biometric recognition transaction device configured to process transaction data according to an aspect as described herein. As shown in FIG. 3, the biometric recognition transaction device may include a voice collection module, a voiceprint instruction module, a biometric feature collection module, a transaction service module, and a status control module. Functions of the biometric recognition transaction device are described below by using an example in which the biometric recognition transaction device is configured to perform palm-scan payment.

(1) Voice collection module: In some aspects as described herein, a microphone array may be disposed on the biometric recognition transaction device, and the microphone array may be used as the voice collection module, configured to collect a voice instruction issued by a cashier (that is, a payee). The microphone array in this aspect as described herein may be configured to directionally collect voice data of a sound source, and a phase and amplitude difference between sound waveforms of voice data received by a plurality of microphones in the microphone array may be used to perform analysis and calculation by using a signal processing algorithm to determine a sound source direction and a sound source position of the sound source, so that directional collection on the sound source is implemented, and further the voice instruction of the cashier can be recognized from directionally collected audio data corresponding to the sound source. In this aspect as described herein, in a directional collection technology related to the microphone array, a signal-to-noise ratio and definition of a voice signal of each voice frame of voice data extracted from the voice instruction can be improved, thereby reducing interference of ambient noise at the sound source.

(2) Biometric feature collection module: As shown in FIG. 3, in this aspect as described herein, a camera (that is, the foregoing photographing device, for example, a three-dimensional (3D) camera) may be disposed on the biometric recognition transaction device as the biometric feature collection module. The biometric feature collection module may be configured to collect a biometric feature of a payer. For example, the biometric feature collection module may be configured to collect a palmprint feature. The camera (for example, the 3D camera) herein mainly includes a red, green, blue (RGB) sensor and an infrared (IR) sensor. To be specific, in the RGB sensor and the IR sensor, the RGB sensor may be configured to capture an RGB image, and the infrared sensor may be configured to capture an infrared image. Based on this, in this aspect as described herein, the RGB image and the infrared image may be used as the target image by using a dual-factor algorithm, to perform fusion recognition on the target image. In the target image, the infrared image captured by using the infrared sensor may be configured for performing liveness detection to identify (that is, determine) whether the current payer is a live subject. Based on this, in this aspect as described herein, liveness detection performed by using the infrared image can effectively improve accuracy and security of biometric feature collection.

In addition, as shown in FIG. 3, a palm-scan module may be disposed in the biometric recognition transaction device. The voiceprint instruction module and the status control module in the following descriptions and the palm-scan module may be integrated into an application, for example, a palm-scan application (APP). In this case, the palm-scan module may be combined with the camera as the biometric feature collection module. For example, when the biometric recognition transaction device collects a palmprint feature of the payer, the palm-scan APP running in the biometric recognition transaction device may invoke the 3D camera to collect streaming media data (for example, an image sequence) corresponding to a current palm of a user (that is, the payer). After obtaining the streaming media data (for example, the image sequence), the palm-scan module performs preferential selection on an image in the streaming media data (for example, the image sequence). Preferential selection may be understood as that an optimal palm image is selected through comprehensive evaluation by using coefficient indexes such as a palm size, an angle, image contrast, and image brightness and definition. Further, the preferentially selected palm image may be collectively referred to as the target image. Subsequently, the palm-scan module may transmit the palm image (that is, the target image) to a back-end service for palm recognition, to further obtain related information such as user identity information or a payment code corresponding to the palm.

(3) Voiceprint instruction module: The voiceprint instruction module mainly includes two functions: voiceprint registration and voice instruction.

Voiceprint registration: When performing voiceprint registration by using the biometric recognition transaction device, the payee (that is, the user) may record a sound sample (that is, the voice sample data) including a plurality of voice features, for example, a voice feature corresponding to a tone, a voice feature corresponding to a volume, a voice feature corresponding to a speed, and a voice feature corresponding to a pronunciation. A sample length of the sound sample (that is, the voice sample data) including the plurality of voice features may be more than 10 seconds. These voice features in the sound sample (that is, the voice sample data) are to be extracted and configured for training to obtain a voiceprint recognition model. In this aspect as described herein, in a process of recording the voice sample data and obtaining the voiceprint recognition model through training, consistency and stability of a collection environment used for collecting the voice sample data may be ensured, thereby ensuring accuracy and reliability when voiceprint matching is performed by using the voiceprint recognition model obtained through training.

After the payee (that is, the user) performs voiceprint registration by using the biometric recognition transaction device, and voiceprint registration succeeds, a voice sample recorded by the payee (that is, the user) may be prestored in the current biometric recognition transaction device, and does not need to be stored in a cloud. Therefore, when a biometric recognition transaction device configured for palm-scan is replaced, a cashier may be re-registered. In this way, a target voiceprint feature of the pre-recorded voice sample is prestored in the biometric recognition transaction device, so that voiceprint recognition and voiceprint matching may be quickly completed locally on the biometric recognition transaction device. Therefore, whether an identity of the user initiating the voice instruction satisfies a requirement may be determined based on the target voiceprint feature prestored in the biometric recognition transaction device.

In this aspect as described herein, during voiceprint registration, no association with an identity of another application is required. For example, when the cashier records voice sample data required for voiceprint registration, a unique identity identifier of a target voiceprint feature stored in a current device (that is, the biometric recognition transaction device) may be allocated to a terminal system. The identity identifier may be configured for marking an identity of each registered user (that is, the target party). In this way, the payee (that is, the user) may perform modification according to a requirement of the payee, for example, perform modification into a name of the payee, provided that the name is not duplicated. As shown in FIG. 3, a registered voiceprint feature (that is, the target voiceprint feature) may be stored in a local voiceprint database shown in FIG. 3, or a voiceprint recognition model obtained through training based on the voiceprint feature (that is, the target voiceprint feature) is stored in the local voiceprint database together, so that voiceprint recognition may be subsequently performed locally by using the local voiceprint database.

Voice instruction: A system may require the cashier to provide a voice instruction carrying voice sample data and configure an instruction function corresponding to the voice instruction, for example, may configure an instruction function corresponding to a voice enabling instruction as enabling a biometric recognition function. The recorded voice sample data is also configured for performing voiceprint feature extraction, and a voiceprint feature extracted from the voice instruction (for example, a sample enabling instruction) during voiceprint registration is used as a target voiceprint feature and stored in the local voiceprint database.

In this way, after receiving the voice enabling instruction initiated by the payee, the biometric recognition transaction device may compare a voiceprint feature extracted from the voice enabling instruction with the target voiceprint feature extracted during previous voiceprint registration for training to obtain the voiceprint recognition model, to determine the identity and authenticity of the payee (that is, the user) when comparison succeeds. If voiceprint recognition succeeds, the system executes the corresponding instruction function. For example, the voice enabling instruction is set to an instruction of “please scan your palm”, and the cashier needs to record a piece of voice sample data of “please scan your palm”, and configures an instruction function corresponding to the voice instruction as enabling a palm-scan function, that is, the biometric recognition transaction device may be controlled in a voice manner, to enable the palm-scan module to enter a palm-scannable state. The voice instruction in this aspect as described herein may be extended according to a habit of the cashier. In addition, the voice instruction may be further extended. For example, after a voice instruction of “please shut down” is recorded, the voice instruction of “please shut down” is configured to be associated with a shut-down operation.

(4) Status control module: As shown in FIG. 3, the biometric recognition transaction device may further include a control center module. The control center module is mainly configured to: control a device and perform an operation based on the configured instruction function. For example, the instruction function corresponding to the voice instruction may be configured by using the control center module, and an association relationship between the voice instruction and the instruction function is stored. For example, a voice instruction of “please scan your palm” may be associated with an instruction function of “the palm-scan device enters the palm-scannable state”. In this way, after the palm-scan module of the biometric recognition transaction device enables the biometric recognition function, and enters the palm-scannable state, a front end may prompt the payer (the user) that palm-scan is available, and at the same time, HID communication used for performing unidirectional communication with the payment receiving device is enabled. It means that in this case, after palmprint recognition succeeds, the biometric recognition transaction device directly outputs a code to a POS machine, that is, unilaterally transmits an obtained payment code of a payer account to the payment receiving device (for example, the POS machine). HID may be understood as a unidirectional communication mode. Usually, a communication mode between the palm-scan transaction device and the POS machine is the HID unidirectional communication mode, that is, the palm-scan device may unidirectionally transmit data to the POS machine.

(5) Transaction service module: As shown in FIG. 3, the transaction service module includes a voiceprint recognition service, a palmprint recognition service, and a transaction payment service. The transaction service module may be integrated in the biometric recognition transaction device, or may be a server capable of performing data communication with the biometric recognition transaction device. This is not specifically limited in this aspect as described herein.

Voiceprint recognition service: The voiceprint recognition service may be mainly configured for obtaining the voiceprint recognition model through training, and converting the voiceprint recognition model obtained through training into a software development kit (SDK) of the biometric recognition transaction device, so that when voiceprint registration and voiceprint recognition are subsequently performed, only the palm-scan transaction device (that is, the biometric recognition transaction device) is required, and the cloud is not required. The voiceprint recognition model in this aspect as described herein is obtained after model training is performed on a Gaussian mixture model based on an algorithm of the Gaussian mixture model. For operations of model training, refer to the following descriptions:
(a) Feature extraction: In this aspect as described herein, after the voice instruction is obtained, a voiceprint feature of the voice signal (that is, the voice signal of each voice frame of the voice data in the voice instruction) in the input voice instruction may be extracted. In this aspect as described herein, in a process of performing voiceprint feature extraction, the voice signal (that is, audio data in the voice instruction) needs to be first preprocessed, for example, by removing noise or reducing a speed, to obtain more pure and noise-free voice data, thereby ensuring accuracy of obtaining the voice data. Then, in this aspect as described herein, a voice signal may be divided into several frames, to ensure that each voice frame may include a voice signal of 20 milliseconds to 30 milliseconds. In this way, for the voice signal of each voice frame obtained through division (that is, each frame of voice signal), the feature of the voice signal may be extracted by using an algorithm such as Mel-frequency cepstral coefficient (MFCC), to obtain a voiceprint feature vector.
(b) Voiceprint recognition model establishment:

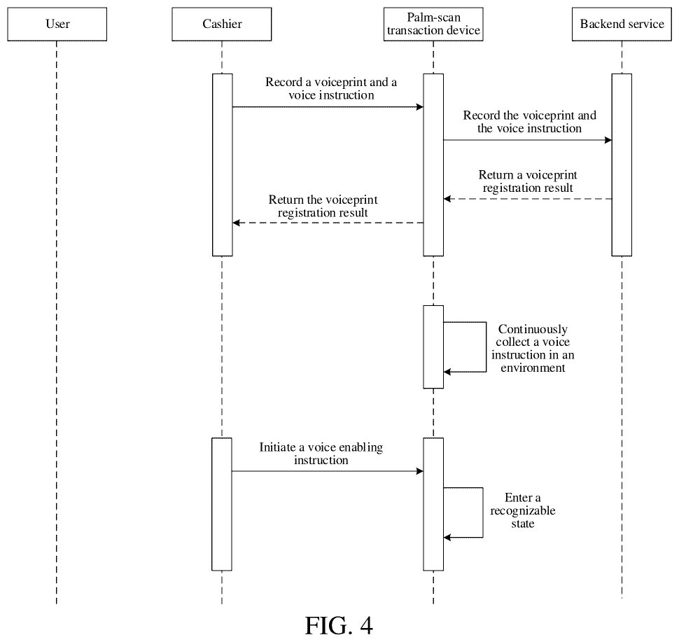

A plurality of voiceprint feature vectors are concatenated in chronological order, to form a feature sequence (that is, a voiceprint feature sequence). Then, in this aspect as described herein, the feature sequence (that is, the voiceprint feature sequence) may be modeled by using a Gaussian mixture model, to obtain the voiceprint recognition model through modeling. The Gaussian mixture model is a statistical model, and may be configured for modeling multidimensional data. In voiceprint recognition, the Gaussian mixture model is usually configured for modeling a probability distribution of a sound feature, that is, each feature vector (that is, each voiceprint feature vector) is regarded as being obtained by sampling a Gaussian distribution. Usually, one voiceprint recognition model may include a plurality of Gaussian distributions. Therefore, a voiceprint recognition model including a plurality of Gaussian distributions may be referred to as a Gaussian mixture model. One voiceprint recognition model may include a plurality of voiceprint recognition sub-models, and each voiceprint recognition sub-model corresponds to a Gaussian distribution of one type of voiceprint feature. Further, FIG. 4 is a schematic diagram of data exchange for enabling a palm-scan payment function of a palm-scan transaction device according to an aspect as described herein. As shown in FIG. 4, when a cashier performs voiceprint registration, a voiceprint and a voice instruction may be recorded by using the palm-scan transaction device shown in FIG. 4, and the recorded voiceprint and voice instruction may be transmitted to a back-end service (that is, a transaction service module), to construct a voiceprint recognition model by using the back-end service (that is, the transaction service module). The voiceprint recorded by the cashier by using the palm-scan transaction device may be a voiceprint feature of voice data carried in a voice enabling instruction recorded by the cashier.
(c) Voiceprint recognition:

Feature extraction and preprocessing also need to be performed on the input voice signal. Then, the feature sequence of the input voice signal is input into the previously established voiceprint recognition model, and a posterior probability of the feature sequence corresponding to each voiceprint recognition sub-model is calculated by using Bayes theorem. In other words, the posterior probability may be configured for representing a probability that the feature sequence comes from a target voiceprint feature corresponding to a voiceprint recognition sub-model. Finally, in this aspect as described herein, based on posterior probabilities obtained through voiceprint matching, a target voiceprint feature having a largest posterior probability may be selected as a recognition result.

Palm-scan recognition service: As shown in FIG. 4, with reference to the record of the foregoing aspect, after the voice instruction (for example, the sample enabling instruction) initiated for voiceprint registration is associated with a configured instruction function on the palm-scan transaction device, the palm-scan transaction device may continuously collect a voice instruction in an environment. In this way, after a payment receiving device completes creation of a transaction order for a current transaction (that is, a target transaction), the cashier may initiate a voice instruction (that is, a voice enabling instruction shown in FIG. 4) to the palm-scan transaction device. Therefore, after collecting the voice instruction (for example, the voice enabling instruction) initiated by the cashier, the palm-scan transaction device may extract a voiceprint feature in the voice instruction (for example, the voice enabling instruction), perform voiceprint matching by using the voiceprint recognition service, and determine, after voiceprint matching succeeds, that an identity of a user (that is, the cashier) initiating the voice instruction (for example, the voice enabling instruction) satisfies a requirement, so that a palm-scan function of the palm-scan transaction device may be enabled, as shown in FIG. 4. In this case, the palm-scan transaction device enters a recognizable state. The recognizable state herein is a working status in which a palmprint feature of a user (for example, a payer) shown in FIG. 4 can be identified and collected. After collecting a palmprint feature of the user (for example, the payer) shown in FIG. 4, the palm-scan transaction device may further recognize the collected palmprint feature, and may obtain associated identity information, such as a payer account, of the user (for example, the payer) based on the palmprint feature of the user (for example, the payer).

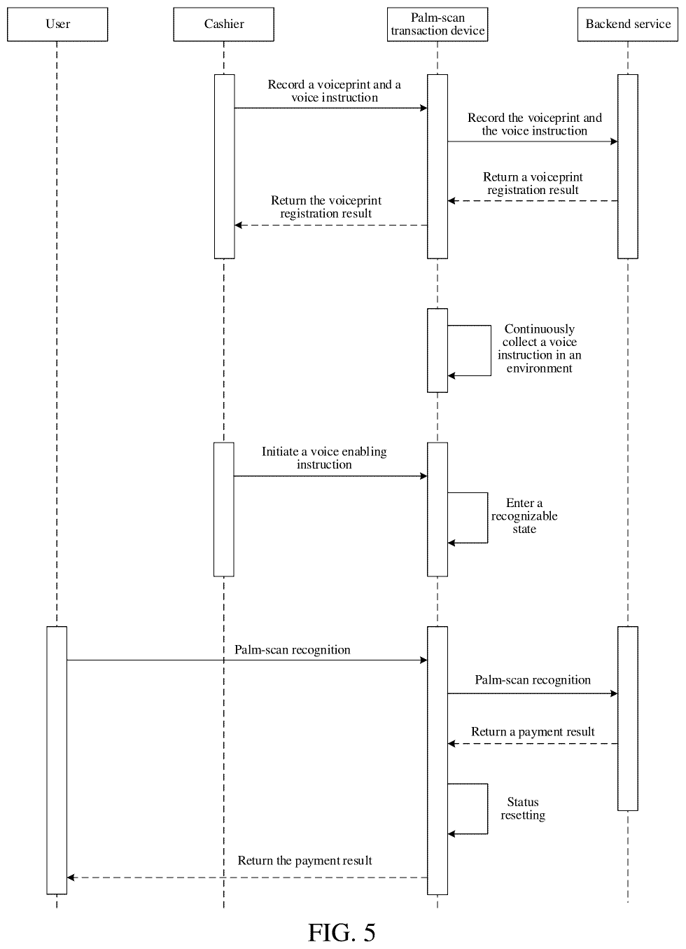

Transaction payment service: The transaction payment service may be configured for completing transaction payment based on identity information and the like of a user (for example, a payer) that are obtained through palmprint recognition. Further, FIG. 5 is a schematic diagram of data exchange of an entire palm-scan payment process according to an aspect as described herein. As shown in FIG. 5, based on the record in the foregoing aspect, after a palm-scan transaction device performs voiceprint registration and association of a voice instruction, a cashier may initiate a voice enabling instruction shown in FIG. 5 to the palm-scan transaction device when a payment receiving device completes creation of a transaction order. In this way, after the palm-scan transaction device enters a recognizable state, a payer (for example, a user shown in FIG. 5) may perform palm-scan recognition. In this case, when performing palm-scan recognition, the palm-scan transaction device may transmit a collected biometric feature (for example, a palmprint feature) of the user (that is, the payer) to a back-end service (that is, a transaction service module) shown in FIG. 5, so that the back-end service obtains, based on the collected palmprint feature, identity information, such as a payer account, of the user (that is, the payer) currently performing palm-scan payment. Further, in this aspect as described herein, transaction payment may also be performed based on the payer account and a virtual resource required for a target transaction in a payment order created by the payment receiving device, and when transaction payment is completed, a payment result after transaction payment for the transaction order is returned to the palm-scan transaction device. As shown in FIG. 5, after receiving the payment result, the palm-scan transaction device may reset a working status of the palm-scan transaction device, for example, may disable a palm-scan function, and return the payment result to the user (that is, the payer), to prompt the user (that is, the payer) to view transaction information for the transaction.

In this aspect as described herein, after the payment receiving device completes creation of the transaction order, the payee may initiate the voice enabling instruction to the biometric recognition transaction device (for example, the palm-scan transaction device), and voiceprint recognition may be further performed based on the voiceprint feature in the voice enabling instruction, so that after the identity of the cashier is confirmed through voiceprint recognition, the palm-scannable state carried in the voice enabling instruction is more conveniently transmitted to the palm-scan device in the voice manner, to avoid a palm-scan failure of the user (that is, the payer) due to the device not being ready. In this way, not only a probability of repeated processing when transaction payment is performed through biometric recognition can be reduced, but also user experience of the user (that is, the payer) in the transaction payment process and transaction data processing efficiency can be improved. In addition, in this aspect as described herein, when enabling of the biometric recognition function is triggered by using the voice instruction, transaction accuracy of transaction payment performed through biometric recognition can be achieved without a need of bidirectional communication between the payment receiving device and the biometric recognition transaction device and cooperation with the payment receiving device to perform technical improvement.

Based on the transaction data processing method, one or more aspects as described herein further provide a terminal and a server end for processing transaction data. The terminal or the server end may include an apparatus (including a distributed system), software (application), a module, a component, a server, a terminal, or the like that uses the method in aspects as described herein, in combination with necessary implementation hardware. Based on a same innovative concept, an apparatus provided in one or more aspects as described herein is described in the following aspects. Implementation solutions of the method and the apparatus are similar. Therefore, for a specific implementation of the apparatus in aspects as described herein, reference may be made to the implementations of the method, and repetitions are not described. The following terms “unit” or “module” may refer to a combination of software and/or hardware having a predetermined function. Although apparatuses described in the following aspects are illustratively implemented by using software, implementations using hardware or a combination of software and hardware are also possible and conceived.

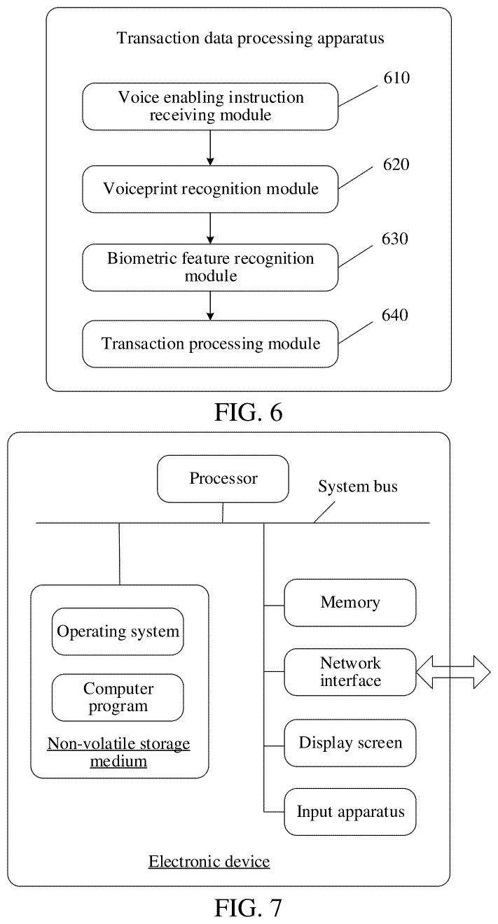

It can be learned from the foregoing technical solutions provided in aspects as described herein that aspects as described herein further provide a transaction data processing apparatus. Further, FIG. 6 is a schematic diagram of a structure of a transaction data processing apparatus according to an aspect as described herein. The transaction data processing apparatus may be applied to a biometric recognition transaction device, and the biometric recognition transaction device is configured to perform unidirectional communication to a payment receiving device. As shown in FIG. 6, the transaction data processing apparatus includes:
a voice enabling instruction receiving module 610, configured to receive a voice enabling instruction initiated by a payee, the voice enabling instruction being initiated by the payee after the payee constructs a transaction order for a target transaction by using the payment receiving device, and the voice enabling instruction being configured for enabling a biometric recognition function of the biometric recognition transaction device;
a voiceprint recognition module 620, configured to: extract a voiceprint feature in the voice enabling instruction, perform matching on the voiceprint feature in the voice enabling instruction and a stored target voiceprint feature, and enable the biometric recognition function according to the voice enabling instruction if matching succeeds;
a biometric feature recognition module 630, configured to: collect a biometric feature of a payer by using the biometric recognition function, and obtain a payer account of the payer based on the collected biometric feature; and
a transaction processing module 640, configured to perform transaction payment for the transaction order based on the payer account and a virtual resource required for the target transaction.

Further, the voice enabling instruction receiving module 610 is specifically configured to:
collect voice data by using a microphone array disposed in the biometric recognition transaction device, and determine, based on the microphone array, a sound source position and a sound source direction that correspond to the collected voice data;
determine, from the voice data based on the sound source position and the sound source direction that correspond to the voice data, target voice data corresponding to a position of the payee; and
use the target voice data as the voice enabling instruction.

Further, the voiceprint recognition module 620 is specifically configured to:
divide audio data carried in the voice enabling instruction into a plurality of voice frames, and extract a voiceprint feature vector corresponding to a voice signal of each of the plurality of voice frames;
concatenate extracted voiceprint feature vectors in chronological order, to obtain a voiceprint feature sequence; and
input the voiceprint feature sequence into a pre-trained voiceprint recognition model, calculate a matching probability between the voiceprint feature sequence and each target voiceprint feature by using the voiceprint recognition model, and if a matching probability between the voiceprint feature sequence and at least one target voiceprint feature is greater than a preset threshold, determine that matching succeeds, and enable the biometric recognition function according to the voice enabling instruction, the voiceprint recognition model being constructed through training based on the target voiceprint feature.

Further, the transaction data processing apparatus further includes a voiceprint recognition model construction module, configured to:
obtain a plurality of pieces of voice sample data configured for training a Gaussian mixture model, divide each of the plurality of pieces of voice sample data into a plurality of voice frames, and use extracted voiceprint feature vectors corresponding to voice signals of the plurality of voice frames in each piece of voice sample data as sample voiceprint feature vectors corresponding to the voice signals in each piece of voice sample data, each piece of voice sample data being voice data that is collected by the biometric recognition transaction device and that is of a target party authorized to enable the biometric recognition function;
concatenate, in chronological order, the extracted sample voiceprint feature vectors corresponding to the voice signals in each piece of voice sample data, to obtain a sample voiceprint feature sequence corresponding to each piece of voice sample data, and use the sample voiceprint feature sequence as the target voiceprint feature; and
extract a probability distribution of the target voiceprint feature by using the Gaussian mixture model, perform model training on the Gaussian mixture model by using the extracted probability distribution of the target voiceprint feature, and use the Gaussian mixture model after model training as the constructed voiceprint recognition model, the voiceprint recognition model including a plurality of voiceprint recognition sub-models, and each voiceprint recognition sub-model corresponding to a Gaussian distribution of one target voiceprint feature.

Further, the transaction data processing apparatus further includes a voiceprint registration module, configured to:
before the voice enabling instruction initiated by the payee is received, receive a voiceprint registration request initiated by the payee, the voiceprint registration request including voice sample data of the payee, a sample enabling instruction corresponding to the voice sample data, and an instruction function corresponding to the sample enabling instruction, and the instruction function including enabling the biometric recognition function of the biometric recognition transaction device;
extract a target voiceprint feature in the voice sample data, and store the target voiceprint feature; and
associate the sample enabling instruction with the instruction function for enabling the biometric recognition function of the biometric recognition transaction device.

Further, the transaction data processing apparatus further includes a transaction query module, configured to:
receive a voice query instruction, the voice query instruction including a query time; and
extract a voiceprint feature in the voice query instruction, perform matching on the voiceprint feature in the voice query instruction and the target voiceprint feature, and query, according to the voice query instruction if matching succeeds, transaction information of the biometric recognition transaction device within the query time.

Further, the voice query instruction further includes an identity identifier of a to-be-queried payee, and the transaction query module is specifically configured to:
perform matching on the voiceprint feature in the voice query instruction and the target voiceprint feature, and query, according to the voice query instruction if matching succeeds, transaction information that is of the biometric recognition transaction device within the query time and that corresponds to the identity identifier.

In some aspects, the transaction processing module 640 is further configured to disable the biometric recognition function after performing transaction payment for the transaction order.

For the apparatus in the foregoing aspect, specific manners in which the modules perform operations have been described in detail in the aspect related to the transaction data processing method, and details are not described herein. The apparatus in the foregoing aspect may further include other implementations based on the descriptions of the method aspect. For a specific implementation, refer to related descriptions of the method aspect. Details are not described herein again.

Further, FIG. 7 is a block diagram of an electronic device configured to process transaction data according to an aspect as described herein. The electronic device may be a terminal, and a diagram of an internal structure may be shown in FIG. 7. The electronic device includes a processor, a memory, a network interface, a display screen, and an input apparatus that are connected through a system bus. The processor of the electronic device is configured to provide computing and control capabilities. The memory of the electronic device includes a non-volatile storage medium and an internal memory. The non-volatile storage medium stores an operating system and a computer program. The internal memory provides an environment for running of the operating system and the computer program in the non-volatile storage medium. The network interface of the electronic device is configured to be connected to and communicate with an external terminal via a network. The computer program implements a transaction data processing method when being executed by the processor. The display screen of the electronic device may be a liquid crystal display screen or an electronic-ink display screen. The input apparatus of the electronic device may be a touch layer covering the display screen, may be a button, a trackball, or a touchpad arranged on a housing of the electronic device, or may be an external keyboard, touchpad, mouse, or the like.

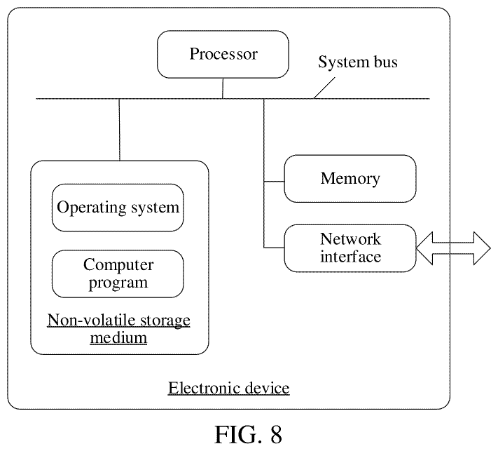

Further, FIG. 8 is a block diagram of another electronic device configured to process transaction data according to an aspect as described herein. The electronic device may be a server, and a diagram of an internal structure may be shown in FIG. 8. The electronic device includes a processor, a memory, and a network interface that are connected through a system bus. The processor of the electronic device is configured to provide computing and control capabilities. The memory of the electronic device includes a non-volatile storage medium and an internal memory. The non-volatile storage medium stores an operating system and a computer program. The internal memory provides an environment for running of the operating system and the computer program in the non-volatile storage medium. The network interface of the electronic device is configured to be connected to and communicate with an external terminal via a network. The computer program implements a transaction data processing method when being executed by the processor.

A person skilled in the art may understand that the structure shown in FIG. 7 or FIG. 8 is only a block diagram of a partial structure related to the solution in aspects as described herein, and does not constitute a limitation on the electronic device to which the solution in aspects as described herein is applied. Specifically, the electronic device may include more components or fewer components than those shown in the figure, or some components may be combined, or different component arrangements may be used.

In an illustrative aspect, an electronic device is further provided. The electronic device includes: a processor; and a memory, configured to store instructions executable by the processor. The processor is configured to execute the instructions, to implement the transaction data processing method in aspects as described herein.

In an illustrative aspect, a computer-readable storage medium is further provided. When instructions in the storage medium are executed by a processor of an electronic device, the electronic device is enabled to perform the transaction data processing method in aspects as described herein.

In an illustrative aspect, a computer program product or a computer program is further provided. The computer program product or the computer program includes computer instructions. The computer instructions are stored in a computer-readable storage medium. A processor of an electronic device reads the computer instructions from the computer-readable storage medium, and the processor executes the computer instructions, so that the electronic device is enabled to perform the transaction data processing method provided in the foregoing various illustrative implementations.

In specific implementations as described herein, relevant data of a user is involved. When the foregoing aspects as described herein are applied to a specific product or technology, permission or consent of the user is required, and collection, use, and processing of the relevant data need to comply with relevant laws, regulations, and standards of relevant countries and regions.

A person of ordinary skill in the art may understand that all or some of procedures of the methods in the foregoing aspects may be implemented by a computer program instructing relevant hardware. The computer program may be stored in a non-volatile computer-readable storage medium. When the computer program is executed, the procedures of the foregoing method aspects may be implemented. References to the memory, the storage, the database, or another medium used in the aspects provided as described herein may all include a non-volatile memory and/or a volatile memory. The non-volatile memory may include a read-only memory (ROM), a programmable ROM (PROM), an electrically programmable ROM (EPROM), an electrically erasable programmable ROM (EEPROM) or a flash memory. The volatile memory may include a random access memory (RAM) or an external cache. As an illustration instead of a limitation, the RAM is available in various forms, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM), a rambus direct RAM (RDRAM), a direct rambus dynamic RAM (DRDRAM), and a rambus dynamic RAM (RDRAM).

A person skilled in the art may easily figure out another implementation solution of aspects as described herein after considering this specification and practicing the present disclosure herein. This application is intended to cover any variations, functions, or adaptive changes of aspects as described herein. These variations, functions, or adaptive changes comply with general principles of aspects as described herein, and include common knowledge or a commonly used technical means in the technical field that is not disclosed in aspects as described herein. This specification and the aspects are considered as merely illustrative, and the scope and spirit of aspects as described herein are pointed out in the following claims.

Aspects as described herein are not limited to the precise structures described above and shown in the accompanying drawings, and various modifications and changes may be made. The scope of aspects as described herein is only limited by the appended claims.

What is claimed is:

1. A computer-implemented method comprising:
receiving, by a biometric recognition transaction device configured to perform unidirectional communication to a payment receiving device, a voice enabling instruction initiated by a payee, the voice enabling instruction being initiated by the payee after the payee constructs a transaction order for a target transaction using the payment receiving device, and the voice enabling instruction being configured for enabling a biometric recognition function of the biometric recognition transaction device;
extracting a voiceprint feature in the voice enabling instruction, performing matching on the voiceprint feature in the voice enabling instruction and a stored target voiceprint feature, and enabling the biometric recognition function according to the voice enabling instruction if matching succeeds;
collecting a biometric feature of a payer using the biometric recognition function, and obtaining a payer account of the payer based on the collected biometric feature; and
performing transaction payment for the transaction order based on the payer account and a virtual resource required for the target transaction.

2. The method according to claim 1, wherein the receiving comprises:
collecting voice data using a microphone array disposed in the biometric recognition transaction device, and determining, based on the microphone array, a sound source position and a sound source direction that correspond to the collected voice data;
determining, from the voice data based on the sound source position and the sound source direction that correspond to the voice data, target voice data corresponding to a position of the payee; and
using the target voice data as the voice enabling instruction.

3. The method of claim 1, wherein the extracting comprises:
dividing audio data carried in the voice enabling instruction into a plurality of voice frames, and extracting a voiceprint feature vector corresponding to a voice signal of each of the plurality of voice frames;
concatenating extracted voiceprint feature vectors in chronological order, to obtain a voiceprint feature sequence; and
inputting the voiceprint feature sequence into a pre-trained voiceprint recognition model, calculating a matching probability between the voiceprint feature sequence and each target voiceprint feature using the voiceprint recognition model, and if a matching probability between the voiceprint feature sequence and at least one target voiceprint feature is greater than a preset threshold, determining that matching succeeds, and enabling the biometric recognition function according to the voice enabling instruction, the voiceprint recognition model being constructed through training based on the target voiceprint feature.

4. The method of claim 3, wherein before the inputting, the method comprises:
obtaining a plurality of pieces of voice sample data configured for training a Gaussian mixture model, dividing each of the plurality of pieces of voice sample data into a plurality of voice frames, and using extracted voiceprint feature vectors corresponding to voice signals of the plurality of voice frames in each piece of voice sample data as sample voiceprint feature vectors corresponding to the voice signals in each piece of voice sample data, each piece of voice sample data being voice data that is collected by the biometric recognition transaction device and that is of a target party authorized to enable the biometric recognition function;
concatenating, in chronological order, the extracted sample voiceprint feature vectors corresponding to the voice signals in each piece of voice sample data, to obtain a sample voiceprint feature sequence corresponding to each piece of voice sample data, and using the sample voiceprint feature sequence as the target voiceprint feature; and
extracting a probability distribution of the target voiceprint feature using the Gaussian mixture model, performing model training on the Gaussian mixture model using the extracted probability distribution of the target voiceprint feature, and using the Gaussian mixture model after model training as the constructed voiceprint recognition model, the voiceprint recognition model comprising a plurality of voiceprint recognition sub-models, and each voiceprint recognition sub-model corresponding to a Gaussian distribution of one target voiceprint feature.

5. The method of claim 1, further comprising:
before the receiving the voice enabling instruction initiated by the payee, receiving a voiceprint registration request initiated by the payee, the voiceprint registration request comprising voice sample data of the payee, a sample enabling instruction corresponding to the voice sample data, and an instruction function corresponding to the sample enabling instruction, and the instruction function comprising enabling the biometric recognition function of the biometric recognition transaction device;
extracting a target voiceprint feature in the voice sample data, and storing the target voiceprint feature; and
associating the sample enabling instruction with the instruction function for enabling the biometric recognition function of the biometric recognition transaction device.

6. The method of claim 1, further comprising:
receiving a voice query instruction, the voice query instruction comprising a query time; and
extracting a voiceprint feature in the voice query instruction, performing matching on the voiceprint feature in the voice query instruction and the target voiceprint feature, and querying, according to the voice query instruction if matching succeeds, transaction information of the biometric recognition transaction device within the query time.

7. The method of claim 1, wherein the voice query instruction further comprises an identity identifier of a to-be-queried payee; and
wherein the extracting the voiceprint feature in the voice enabling instruction, performing matching on the voiceprint feature in the voice enabling instruction and the stored target voiceprint feature, and enabling the biometric recognition function according to the voice enabling instruction if matching succeeds, comprises:
performing matching on the voiceprint feature in the voice query instruction and the target voiceprint feature, and querying, according to the voice query instruction if matching succeeds, transaction information that is of the biometric recognition transaction device within the query time and that corresponds to the identity identifier.

8. The method of claim 1, further comprising:
disabling the biometric recognition function after performing transaction payment for the transaction order.

9. One or more non-transitory computer readable media comprising computer readable instructions that, when executed by a processor, configure a data processing system to perform:
receiving, by a biometric recognition transaction device configured to perform unidirectional communication to a payment receiving device, a voice enabling instruction initiated by a payee, the voice enabling instruction being initiated by the payee after the payee constructs a transaction order for a target transaction using the payment receiving device, and the voice enabling instruction being configured for enabling a biometric recognition function of the biometric recognition transaction device;
extracting a voiceprint feature in the voice enabling instruction, performing matching on the voiceprint feature in the voice enabling instruction and a stored target voiceprint feature, and enabling the biometric recognition function according to the voice enabling instruction if matching succeeds;
collecting a biometric feature of a payer using the biometric recognition function, and obtaining a payer account of the payer based on the collected biometric feature; and
performing transaction payment for the transaction order based on the payer account and a virtual resource required for the target transaction.

10. The computer readable media according to claim 9, wherein the receiving comprises:
collecting voice data using a microphone array disposed in the biometric recognition transaction device, and determining, based on the microphone array, a sound source position and a sound source direction that correspond to the collected voice data;
determining, from the voice data based on the sound source position and the sound source direction that correspond to the voice data, target voice data corresponding to a position of the payee; and
using the target voice data as the voice enabling instruction.

11. The computer readable media of claim 9, wherein the extracting comprises:
dividing audio data carried in the voice enabling instruction into a plurality of voice frames, and extracting a voiceprint feature vector corresponding to a voice signal of each of the plurality of voice frames;
concatenating extracted voiceprint feature vectors in chronological order, to obtain a voiceprint feature sequence; and
inputting the voiceprint feature sequence into a pre-trained voiceprint recognition model, calculating a matching probability between the voiceprint feature sequence and each target voiceprint feature using the voiceprint recognition model, and if a matching probability between the voiceprint feature sequence and at least one target voiceprint feature is greater than a preset threshold, determining that matching succeeds, and enabling the biometric recognition function according to the voice enabling instruction, the voiceprint recognition model being constructed through training based on the target voiceprint feature.

12. The computer readable media of claim 11, wherein before the inputting, the method comprises:
obtaining a plurality of pieces of voice sample data configured for training a Gaussian mixture model, dividing each of the plurality of pieces of voice sample data into a plurality of voice frames, and using extracted voiceprint feature vectors corresponding to voice signals of the plurality of voice frames in each piece of voice sample data as sample voiceprint feature vectors corresponding to the voice signals in each piece of voice sample data, each piece of voice sample data being voice data that is collected by the biometric recognition transaction device and that is of a target party authorized to enable the biometric recognition function;
concatenating, in chronological order, the extracted sample voiceprint feature vectors corresponding to the voice signals in each piece of voice sample data, to obtain a sample voiceprint feature sequence corresponding to each piece of voice sample data, and using the sample voiceprint feature sequence as the target voiceprint feature; and
extracting a probability distribution of the target voiceprint feature using the Gaussian mixture model, performing model training on the Gaussian mixture model using the extracted probability distribution of the target voiceprint feature, and using the Gaussian mixture model after model training as the constructed voiceprint recognition model, the voiceprint recognition model comprising a plurality of voiceprint recognition sub-models, and each voiceprint recognition sub-model corresponding to a Gaussian distribution of one target voiceprint feature.

13. The computer readable media of claim 9, further comprising:
before the receiving the voice enabling instruction initiated by the payee, receiving a voiceprint registration request initiated by the payee, the voiceprint registration request comprising voice sample data of the payee, a sample enabling instruction corresponding to the voice sample data, and an instruction function corresponding to the sample enabling instruction, and the instruction function comprising enabling the biometric recognition function of the biometric recognition transaction device;
extracting a target voiceprint feature in the voice sample data, and storing the target voiceprint feature; and
associating the sample enabling instruction with the instruction function for enabling the biometric recognition function of the biometric recognition transaction device.

14. The computer readable media of claim 9, further comprising:
receiving a voice query instruction, the voice query instruction comprising a query time; and
extracting a voiceprint feature in the voice query instruction, performing matching on the voiceprint feature in the voice query instruction and the target voiceprint feature, and querying, according to the voice query instruction if matching succeeds, transaction information of the biometric recognition transaction device within the query time.

15. The computer readable media of claim 9, wherein the voice query instruction further comprises an identity identifier of a to-be-queried payee; and
wherein the extracting the voiceprint feature in the voice enabling instruction, performing matching on the voiceprint feature in the voice enabling instruction and the stored target voiceprint feature, and enabling the biometric recognition function according to the voice enabling instruction if matching succeeds, comprises:
performing matching on the voiceprint feature in the voice query instruction and the target voiceprint feature, and querying, according to the voice query instruction if matching succeeds, transaction information that is of the biometric recognition transaction device within the query time and that corresponds to the identity identifier.

16. The computer readable media of claim 9, further comprising:
disabling the biometric recognition function after performing transaction payment for the transaction order.

17. A biometric recognition transaction device configured to process transaction data, the biometric recognition transaction device comprising:
a processor;
a voice collection module, configured by instructions stored in memory that, when executed by the processor, collect a voice enabling instruction of a payee, the voice enabling instruction being initiated by the payee after a payment receiving device constructs a transaction order for a target transaction, the voice enabling instruction being configured for enabling a biometric recognition function of the biometric recognition transaction device, and the biometric recognition transaction device being configured to perform unidirectional communication to the payment receiving device;
a voiceprint instruction module, configured by instructions stored in memory that, when executed by the processor, perform voiceprint registration and associate the voice enabling instruction with a configured instruction function;
a biometric feature collection module, configured to collect a biometric feature of a payer;
a transaction service module, configured by instructions stored in memory that, when executed by the processor, perform voiceprint recognition on the voice enabling instruction collected by the voice collection module, perform matching on a voiceprint feature in the voice enabling instruction and a target voiceprint feature, when matching succeeds, enable the biometric recognition function, and perform biometric recognition on the biometric feature collected by the biometric feature collection module, and when biometric recognition succeeds, obtain a payer account of the payer corresponding to the biometric feature, and perform transaction payment for the transaction order based on the payer account and a virtual resource required for the target transaction; and
a status control module, configured by instructions stored in memory that, when executed by the processor, after the transaction service module determines that matching on the voiceprint feature in the voice enabling instruction succeeds, enable the biometric recognition function based on the instruction function associated with the voice enabling instruction.

18. The device of claim 17, further configured to perform:
before the receiving the voice enabling instruction initiated by the payee, receiving a voiceprint registration request initiated by the payee, the voiceprint registration request comprising voice sample data of the payee, a sample enabling instruction corresponding to the voice sample data, and an instruction function corresponding to the sample enabling instruction, and the instruction function comprising enabling the biometric recognition function of the biometric recognition transaction device;
extracting a target voiceprint feature in the voice sample data, and storing the target voiceprint feature; and
associating the sample enabling instruction with the instruction function for enabling the biometric recognition function of the biometric recognition transaction device.

19. The device of claim 17, further configured to perform:
receiving a voice query instruction, the voice query instruction comprising a query time; and
extracting a voiceprint feature in the voice query instruction, performing matching on the voiceprint feature in the voice query instruction and the target voiceprint feature, and querying, according to the voice query instruction if matching succeeds, transaction information of the biometric recognition transaction device within the query time.

20. The device of claim 17, wherein the voice query instruction further comprises an identity identifier of a to-be-queried payee; and
wherein the extracting the voiceprint feature in the voice enabling instruction, performing matching on the voiceprint feature in the voice enabling instruction and the stored target voiceprint feature, and enabling the biometric recognition function according to the voice enabling instruction if matching succeeds, comprises:
performing matching on the voiceprint feature in the voice query instruction and the target voiceprint feature, and querying, according to the voice query instruction if matching succeeds, transaction information that is of the biometric recognition transaction device within the query time and that corresponds to the identity identifier.
